(19) United States
(12) Patent Application Publication
(10) Pub. No.: US 2026/0212297 A1
(43) Pub. Date: Jul. 23, 2026

(54) BATCH RECALL RISK ASSESSMENT AND OPTIMIZATION

(71) Applicant: Honeywell International Inc., Charlotte, NC (US)

(72) Inventors: Waad Subber, Schenectady, NY (US); Ankit Singh, Apex, NC (US)

(21) Appl. No.: 19/032,454

(22) Filed: Jan. 21, 2025

(51) Int. Cl. G06Q 10/0635; G06Q 10/04

(52) U.S. Cl. CPC G06Q 10/0635; G06Q 10/04

(57) ABSTRACT

Approaches for automated assessment and optimization of recall risk associated with product batches are described. According to one example, a batch production plan (BPP) corresponding to a product batch is obtained and analyzed to compute a global recall risk value associated with manufacturing the product batch utilizing the BPP. The BPP may describe multiple production stages and indicate control variables governing performance parameters of the production stages. Parameter-specific recall risk values for the performance parameters of all the production stages are calculated and aggregated to compute the global recall risk value. If the global recall risk value is greater than a desired threshold risk value, candidate control variables within the BPP are modified to improvise candidate performance parameters for optimizing the BPP and generating an optimized batch production plan (OBPP). The OBPP has an optimized global recall risk value equal to or lower than the desired threshold risk value.

### BACKGROUND

Various products, such as pharmaceutical products, vehicles, electronic devices, daily-use products, etc., are typically produced and distributed in product batches. A product batch, for instance, may include a specific quantity of medication units, manufactured concurrently or using identical processes and raw materials. Whenever certain products within a particular product batch, distributed by the manufacturer to suppliers or customers, are identified to be severely defective or unsafe for use or consumption, the particular product batch may be recalled as a whole.

Recalling product batches may lead to heavy monetary losses for an organization. However, not recalling product batches having severely defective or unsafe products may jeopardize consumer's lives and may lead to huge reputational and financial damage for the organization. Further, the organization may suffer regulatory penalties or legal repercussions. Thus, it is important for an organization to efficiently assess and substantiate a recall risk associated with product batches produced by the organization so that well-informed decisions may be made about recalling the product batches in a timely manner.

### BRIEF DESCRIPTION OF FIGURES

Systems and/or methods are now described, in accordance with examples of the present subject matter and with reference to the accompanying figures, in which:

FIG. 1 illustrates a system for assessing recall risk associated with a product batch, according to an example;

FIG. 2 illustrates a computing environment implementing the system for assessing and optimizing recall risk associated with a product batch, according to another example;

FIG. 3 illustrates a block diagram depicting an exemplary two-dimensional chain for determining a global recall risk value associated with a product batch, according to an example;

FIG. 4 illustrates a block diagram depicting an exemplary data flow for determining a global recall risk value associated with a product batch, according to another example;

FIGS. 5A to 5C illustrate exemplary graphs of recall risk values determined for a product batch by the system, according to an example;

FIG. 6 illustrates a schematic diagram depicting an exemplary data flow for optimizing recall risk associated with a product batch, according to an example;

FIG. 7 illustrates a method for assessing recall risk associated with a product batch, according to an example;

FIG. 8 illustrates a method for determining parameter-specific recall risk values for assessing recall risk associated with a product batch, according to an example;

FIG. 9 illustrates a method for determining parameter-specific recall risk values for assessing recall risk associated with a product batch, according to another example;

FIGS. 10A to 10C illustrate a method for optimizing recall risk associated with a product batch, according to an example; and

FIG. 11 illustrates a computing environment implementing a non-transitory computer-readable medium for assessing and optimizing recall risk associated with a product batch, according to an example.

### DETAILED DESCRIPTION

Typically, organizations investigate product batches to assess the need for recalling the product batches in response to specific quality or safety triggers. The quality or safety triggers may originate from various sources. For instance, an organization may initiate an investigation of a product batch produced by the organization when defective or unsafe products are identified during the organization's internal quality-related investigations or upon processing a customer's complaint or based on observation of regulatory bodies, such as the food and drug administration (FDA). Thus, rather than proactively investigating product batches, organizations typically follow a reactive approach whereby the investigations are often initiated when products of the product batches have already reached end customer for use. The reactive approach limits the ability of the organizations to pre-emptively mitigate recall risks and reduce the likelihood of batch recalls. Therefore, there is a need for techniques that proactively optimize the recall risk associated with product batches for reducing the likelihood of batch recalls.

Further, organizations typically have dedicated human resources for making decisions about recalling a particular product batch. For an organization, the dedicated human resources may perform quality checks for products produced by the organization to detect if any product is defective or unsafe. The dedicated human resources may process complaints from customers to detect if any product is defective or unsafe. Upon ascertaining, through any means, that some products manufactured by the organization are defective or unsafe, the dedicated human resources may perform investigations to check the nature and severity of flaws within the defective or unsafe products. Based on the investigation, the dedicated human resources make decision on whether to recall the product batches having such defective or unsafe products. Thus, before finally making decision about recalling product batches, the dedicated human resources are required to go through various phases of investigations which are often time and cost intensive.

Due to high dependency on human resources and existence of various phases of investigations involving manual effort, the process of making a recall decision becomes a time consuming and a tedious task, leading to unnecessary delays in making the recall decision. Delay in making the recall decision may turn out to be highly disadvantageous for the organization as such a delay may increase regulatory penalties, customer compensations, legal liabilities, and damage control costs. Further, risks of human errors while making the recall decision are also typically high. Such human errors may either lead to recalling of product batches which were not required to be recalled, or non-recalling of product batches which were actually required to be recalled. Errors in the recall decision may jeopardize lives of the consumers of the products and may lead to unnecessary monetary losses for the organization. The problems associated with the delay and the errors in the recall decision may further escalate as the number of products and product batches belonging to the organization increases. Thus, the traditional techniques are highly inefficient in timely and accurately identifying product batches which should be recalled. Therefore, there is a need for techniques that efficiently make decisions for recalling product batches.

The present subject matter describes approaches for automated assessment and optimization of recall risk associated with product batches produced by an organization. The approach involves obtaining and analyzing a batch production plan (BPP) corresponding to a product batch to compute a global recall risk value associated with manufacturing the product batch utilizing the BPP. The BPP may describe multiple production stages. Further, the BPP may indicate one or more control variables governing one or more performance parameters of the plurality of production stages. Instead of considering recall risk associated with only some performance parameters, parameter-specific recall risk values for the performance parameters of all the production stages are calculated and aggregated to compute the global recall risk value. The global recall risk value may be predicted before implementation of the BPP, and the global recall risk value may be recurrently updated during implementation of the BPP. A risk assessment report may be generated for the product batch for transmission to a user device, where the risk assessment report may include the global recall risk value.

If the global recall risk value is determined to be greater than a desired threshold risk value, candidate control variables within the BPP may be modified to improvise candidate performance parameters for optimizing the BPP and generating an optimized batch production plan (OBPP). A risk optimization report may be generated for the product batch for transmission to a user device, where the risk optimization report may include the OBPP. The OBPP may have an optimized global recall risk value equal to or lower than the desired threshold risk value. The present subject matter thus provides a comprehensive and proactive approach to recall risk management in complex batch production processes by integrating risk assessments from multiple production stages into a unified and accurate global risk profile, enabling informed decision-making and targeted optimization. Further, the present subject matter enables dynamic, data-driven optimization of batch productions plans by identifying and modifying control variables across multiple production stages, thereby minimizing recall risks of product batches.

In an example implementation of the present subject matter, for computing the global recall risk value, initially, a parameter-specific risk determination model may be utilized for analyzing the one or more control variables governing each production stage. The one or more control variables may be analyzed to determine a parameter-specific recall risk value corresponding to each of the one or more performance parameters of the production stage. Parameter-specific recall risk values determined for the one or more performance parameters may be aggregated to generate a stage-specific recall risk value for the production stage. Then, stage-specific recall risk values generated for the plurality of production stages may be aggregated to generate a global recall risk value associated with manufacturing the product batch utilizing the BPP.

In an example, for optimizing the BPP, at least one candidate performance parameter, from amongst the one or more performance parameters, may be identified for improvisation, for at least one of the plurality of production stages. Further, at least one candidate control variable governing the at least one candidate performance parameter may be identified. The at least one candidate control variable may be modified to improvise the at least one candidate performance parameter for optimizing the BPP. The at least one candidate control variable within the BPP may then be modified to generate the OBPP for the product batch.

In an example, for modifying the at least one candidate control variable within the BPP to generate the OBPP, an alternate control variable corresponding to each of the at least one candidate control variable may be determined for optimizing the BPP. Then, each of the at least one candidate control variable within the BPP may be replaced with the corresponding alternate control variable to generate the OBPP for the product batch.

In another example, for modifying the at least one candidate control variable within the BPP to generate the OBPP, a list of pre-stored control variables associated with the at least one candidate performance parameter may be obtained. Then, it may be ascertained whether any pre-stored control variable, from the list of pre-stored control variables, is plausible to be an alternate control variable corresponding to each of the at least one candidate control variable for optimizing the BPP. For generating the OBPP, for each candidate control variable ascertained to have a single alternate control variable in the list of pre-stored control variables, the candidate control variable within the BPP may be replaced with the corresponding single alternate control variable. Further, for each candidate control variable ascertained to have a plurality of alternate control variables in the list of pre-stored control variables, an interactive query dialog seeking a user input for selecting a particular alternate control variable from the plurality of alternate control variables may be generated. A user input specifying the particular alternate control variable may be received. Then, the candidate control variable within the BPP may be replaced with the particular alternate control variable to generate the OBPP.

By aggregating risk assessments from multiple production stages into a unified global risk profile, the present subject matter provides an accurate and reliable risk assessment, enabling the organization to make more informed decisions about recalling of the product batches. Further, the present subject matter continuously monitors the BPP before the implementation of the BPP and during implementation of the BPP, enabling efficient and timely optimization of the BPP to minimize potential batch recalls. Thus, the present subject matter provides a comprehensive and integrated approach to batch recall risk assessment and optimization even for complex batch production plans.

The present subject matter provides automated techniques for recall assessment and optimization by identifying control variables to be modified within the BPP to prevent recalling of the product batch. Automated batch recall risk assessment and optimization based on probabilistic risk determination of the performance parameters not only makes the assessment accurate but also helps eliminate human errors. By identifying control variables and performance parameters for modification across different production stages, and then modifying the control variables using optimal alternatives, the present subject matter generates an optimized batch production plan that balances recall risk reduction with operational constraints. The present subject matter thus enables early, quick, efficient, accurate, and automated optimization of the BPP reducing the possibility of a potential batch recall.

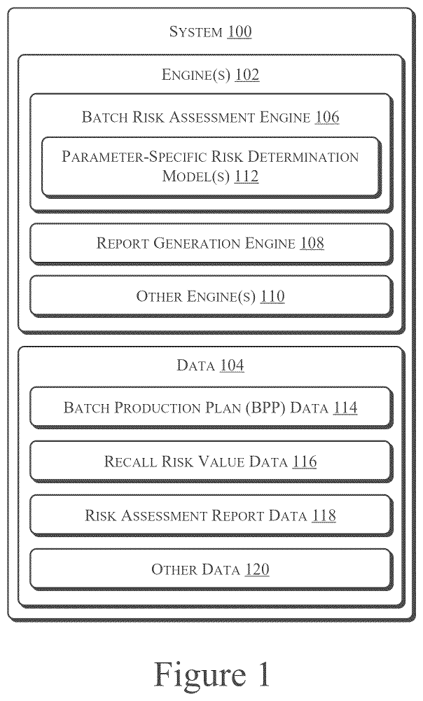

The present subject matter is further described with reference to FIG. 1 to FIG. 11. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for assessing recall risk associated with a product batch, according to an example. In one example, the system 100 may be a distributed computing system having one or more physical computing systems geographically distributed at same or different locations. In another example, one or more components of the system 100 may be hosted virtually, for example, on a cloud-based platform, while other components may be geographically distributed at same or different locations. In yet another example, the system 100 may be a stand-alone physical system geographically located at a particular location. In an example, the system 100 may be utilized by users associated with an organization for determining and reducing recall risk associated with product batches produced, to be produced, or being produced by the organization.

In one example, the system 100 may include engine(s) 102 and data 104. The system 100 may also include additional components, such as display, input/output interfaces, operating systems, applications, and other software or hardware components (not shown in the figures).

The engine(s) 102 may be implemented as a combination of hardware and programming, for example, programmable instructions to implement a variety of functionalities of the engine(s) 102. In examples described herein, such combinations of hardware and programming may be implemented in several different ways. For example, the engine(s) 102 may be programmed using executable instructions. Such instructions may be stored on a non-transitory machine-readable storage medium which may be coupled either directly with the system 100 or indirectly (for example, through networked means). In an example, the engine(s) 102 may include a processing resource, for example, either a single processor or a combination of multiple processors, to execute such instructions. In the present examples, the non-transitory machine-readable storage medium may store instructions that, when executed by the processing resource, implement the engine(s) 102. In other examples, the engine(s) 102 may be implemented as electronic circuitry.

In one example, the engine(s) 102 may include a batch risk assessment engine 106, a report generation engine 108, and other engine(s) 110. The other engine(s) 110 may further implement functionalities that supplement functions performed by the system 100 or any of the engine(s) 102. The batch risk assessment engine 106 may be configured to implement parameter-specific risk determination model(s) 112 for assessing the recall risk associated with the product batch. Each parameter-specific risk determination model of the parameter-specific risk determination model(s) 112 may hereinafter be alternatively referred to as parameter-specific risk determination model 112. In an example, each parameter-specific risk determination model 112 may be a machine learning (ML) model, for example, a ML-based probabilistic model, that may be specifically trained for determining a parameter-specific recall risk value for a particular performance parameter related to production of the product batch. Examples of the particular performance parameter may include, but are not limited to, supplier delays, packaging defects, and transportation delays.

The data 104 includes data that is either received, stored, or generated as a result of functions implemented by any of the engine(s) 102 or the system 100. It may be further noted that information stored and available in the data 104 may be utilized by the engine(s) 102 for performing various functions of the system 100. The data 104 may include batch production plan (BPP) data 114, recall risk value data 116, risk assessment report data 118, and other data 120. The BPP data 114 may include data related to batch production plans that may be utilized by the organization for producing the product batches associated with the organization. The recall risk value data 116 may include data associated with recall risk values determined by the system 100 in relation to the product batches associated with the organization. The risk assessment report data 118 may include data associated with risk assessment reports generated by the system 100 in relation to the product batches associated with the organization. The other data 120 may include data that is either received, stored, or generated as a result of functions implemented by any of the engine(s) 102.

In operation, for assessing recall risk associated with a product batch, the batch risk assessment engine 106 may obtain a batch production plan (BPP) corresponding to the product batch. In an example, the BPP may be obtained from a user associated with the organization. In another example, the BPP may be pre-stored in a memory of the system 100 and may be obtained from the memory. The BPP may describe a plurality of production stages involved in production of the product batch. In one example, the BPP may be stored within the BPP data 114. Examples of the plurality of production stages may include, but are not limited to, a raw material sourcing stage, a product manufacturing stage, a product packaging stage, a product storage stage, and a product distribution stage. Further, for each production stage of the plurality of production stages, the BPP may indicate one or more control variables governing one or more performance parameters of the production stage.

For instance, for the raw material sourcing stage, the one or more control variables may include, but are not limited to, raw material specification and raw material supplier specification. For the product manufacturing stage, the one or more control variables may include, but are not limited to, product specification, manufacturing equipment specification, product batch size, environmental conditions, raw material ratios, and product manufacturing process specification. For the product packaging stage, the one or more control variables may include, but are not limited to, packaging material specification, sealing temperature and pressure values, packaging equipment specification, product label information, and product label placement details. For the product storage stage, the one or more control variables may include, but are not limited to, a warehouse address, storage temperature range, light exposure limits, and humidity control settings. For the product distribution stage, the one or more control variables may include, but are not limited to, transportation mode, temperature range during transit, product handling procedure specification, and transportation route.

The one or more performance parameters may be production parameters that are crucial for reducing the recall risk associated with the product batch. The one or more performance parameters of the production stage may be influenced by managing and optimizing the one or more control variables of the production stage. For the raw material sourcing stage, examples of the one or more performance parameters may include, but are not limited to, raw material quality, raw material delay, and supplier issues. For the product manufacturing stage, examples of the one or more performance parameters may include, but are not limited to, product quality, production issues, and contamination issues. For the product packaging stage, example of the one or more performance parameters may include, but is not limited to, packaging defects. For the product storage stage, example of the one or more performance parameters may include, but is not limited to, storage temperature deviations. For the product distribution stage, examples of the one or more performance parameters may include, but are not limited to, production destination issues, transportation delays, shipping steps frequency issues, transportation temperature issues, and location handling issues.

Once the BPP is obtained, for each production stage, the batch risk assessment engine 106 may analyze the one or more control variables governing the production stage to determine a parameter-specific recall risk value corresponding to each of the one or more performance parameters of the production stage. In an example, the one or more control variables may be analyzed using the parameter-specific risk determination model 112. For instance, for the raw material sourcing stage, a first parameter-specific recall risk value may be determined corresponding to the raw material quality, a second parameter-specific recall risk value may be determined corresponding to the raw material delay, and a third parameter-specific recall risk value may be determined corresponding to the supplier issues. Similarly, parameter-specific recall risk values may be determined for the one or more performance parameters of each production stage.

The parameter-specific recall risk value may be a quantitative measure that represents the likelihood of recall of the product batch due to issues or deviations associated with the corresponding performance parameter within the corresponding production stage. The parameter-specific recall risk value may be expressed as a probability or a normalized score between 0 and 1, where higher values may indicate a greater risk of the recall. For instance, if the first parameter-specific recall risk value is determined to be 0.8, there would be 0.8 probability of recall risk associated with manufacturing the product batch utilizing the BPP in the present form, for example, due to poor quality of raw material being received from a particular supplier involved in the BPP in the present form. While the parameter-specific recall risk value has been explained using normalized format, the parameter-specific recall risk value may be expressed using any other scale. In one example, the parameter-specific recall risk values may be stored within the recall risk value data 116.

For each production stage, the batch risk assessment engine 106 may aggregate parameter-specific recall risk values determined for the one or more performance parameters to generate a stage-specific recall risk value for the production stage. Thus, multiple parameter-specific recall risk values may be combined into a single, comprehensive risk value for an entire production stage, taking into account all the performance parameters. In an example, the parameter-specific recall risk values may be aggregated utilizing different statistical methods, such a Bayesian mechanism. The stage-specific recall risk value may be a comprehensive measure that represents the overall likelihood of recall of the product batch due to issues or deviations associated with an entire production stage of the BPP. The stage-specific recall risk value may be expressed as a probability or a normalized score between 0 and 1, where higher values may indicate a greater risk of the recall. In one example, the stage-specific recall risk values generated for the plurality of production stages may be stored within the recall risk value data 116.

The batch risk assessment engine 106 may then aggregate the stage-specific recall risk values generated for the plurality of production stages to generate a global recall risk value associated with manufacturing the product batch utilizing the BPP. In an example, the stage-specific recall risk values may be aggregated utilizing different statistical methods, such a Bayesian mechanism. The global recall risk value may be a comprehensive measure that represents the overall likelihood of recall of the product batch if the product batch is produced using the BPP. The global recall risk value encompasses the recall risks from all production stages and the performance parameters corresponding to the production stage, providing a single, unified risk assessment for the BPP. In one example, the global recall risk value may be stored within the recall risk value data 116.

The report generation engine 108 may generate a risk assessment report for the product batch for transmission to a user device. Examples of the user device may include, but are not limited to, a desktop computer, a laptop, a tablet, a smartphone, and a wearable device. The risk assessment report may be a structured document containing key information about recall risk assessment for the product batch. The risk assessment report may include the global recall risk value. In one example, the risk assessment report may be stored within the risk assessment report data 118.

A user associated with the organization may access the risk assessment report through the user device. Utilizing the risk assessment report, the user may quickly assess recall risk profile of the product batch and make informed decisions about whether to proceed with production as planned or implement modifications to the BPP to reduce the recall risk associated with the product batch. Thus, the present subject matter provides a streamlined approach to risk assessment and decision-making, leading to improved product quality, reduced batch recall incidents, and more efficient manufacturing processes.

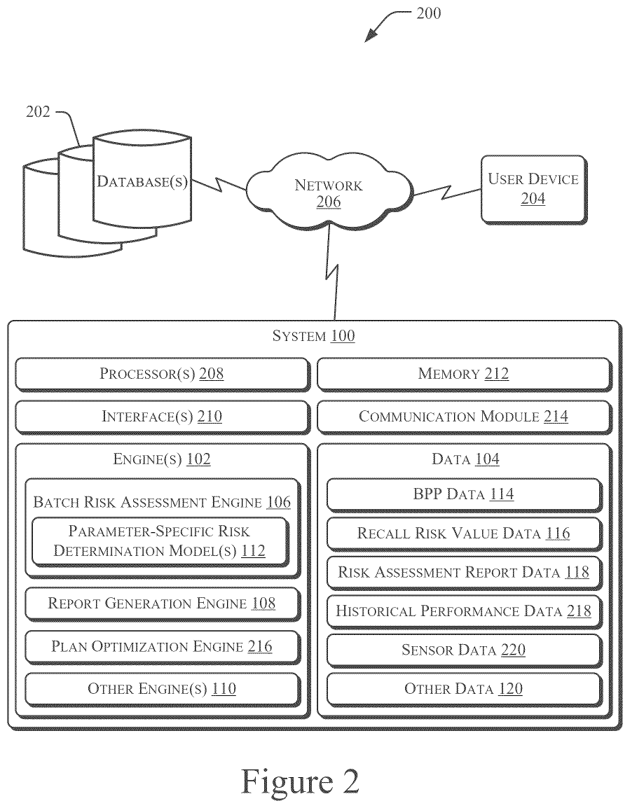

FIG. 2 illustrates a computing environment 200 implementing the system 100 for assessing and optimizing recall risk associated with a product batch, according to another example. In one example, the computing environment 200 may include the system 100, database(s) 202, and a user device 204. The database(s) 202 may be individually referred to as database 202 and collectively referred to as the databases 202. The database 202 may have the capabilities to store data in structured or unstructured formats. The database 202 may store and manage a wide variety of information crucial to production of a product batch. For example, the database 202 may store performance trends, patterns, and outcomes of batch production plans, equipment, raw materials, and products over time. In an example, the database 202 may be a distributed computing system having one or more physical computing systems geographically distributed at same or different locations. In another example, one or more components of the database 202 may be hosted virtually, for example, on a cloud-based platform, while other components may be geographically distributed at same or different locations. In yet another example, the database 202 may be a stand-alone physical system geographically located at a particular location.

In an example, the user device 204 may be any electronic device that allows a user to access, view, and interact with digital information or applications. In an example, the user device 204 may be a device utilized by a user to trigger the system 100 to initiate recall risk assessment and optimization associated with a product batch. Further, the system 100 may provide various notifications over the user device 204 to notify the user of results of the recall risk assessment and optimization. Examples of the user device 204 may include, but are not limited to, a smartphone, a laptop, a mobile phone, and a computer. Examples of the user device 204 may also include, but are not limited to, a desktop, a tablet computer, a wearable electronic device, a personal digital assistant (PDA), and any electronic device capable of transmitting or receiving data.

The system 100, the databases 202, and the user device 204 may be communicably coupled with each other over a communication network 206 and may exchange data and signals over the communication network 206. The communication network 206 may be a wireless network, a wired network, or a combination thereof. The communication network 206 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

Depending on the technology, the communication network 206 may include various network entities, such as transceivers, gateways, and routers. In an example, the communication network 206 may include any communication network that uses any of the commonly used protocols, for example, Hypertext Transfer Protocol (HTTP), and Transmission Control Protocol/Internet Protocol (TCP/IP).

In one example, the system 100 may include processor(s) 208, interface(s) 210, memory 212, a communication module 214, the engine(s) 102, and the data 104. The system 100 may also include other components, such as display, input/output interfaces, operating systems, applications, and other software or hardware components (not shown in the figures).

The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the system 100 with one or more other devices, such as the databases 202 and the user device 204, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory or an internal memory, such as a flash drive, a compact disk drive, an external hard disk drive, or the like. The memory 212 may further include the data 104 and/or other data which may either be received, utilized, or generated during the operation of the system 100.

The communication module 214 may be a wireless communication module. Examples of the communication module 214 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 214 may also include one or more antennas to enable wireless transmission and reception of data and signals. The communication module 214 may allow the system 100 to transmit data and signals to one or more other devices, such as the databases 202 and the user device 204; and receive data and signals from the one or more other devices.

The engine(s) 102 may include the batch risk assessment engine 106, the report generation engine 108, and the other engine(s) 110, as explained with reference to FIG. 1. The batch risk assessment engine 106 may be configured to implement the parameter-specific risk determination model(s) 112 for assessing the recall risk associated with the product batch. The engine(s) 102 may further include a plan optimization engine 216.

The data 104 may include the batch production plan (BPP) data 114, the recall risk value data 116, the risk assessment report data 118, and other data 120, as explained with reference to FIG. 1. In an example, the data 104 may further include historical performance data 218 and sensor data 220. In an example, the historical performance data 218 may include past records and measurements related to various aspects of the batch production plan and product quality. The historical performance data 218 may capture the performance trends, patterns, and outcomes of the batch production plan, equipment, raw materials, and products over time. It typically includes. For example, the historical performance data 218 may include performance metrics associated with a raw material supplier, raw material, and a product manufacturing process. The sensor data 220 may include actual sensor data or forecasted sensor data associated with one or more sensor devices utilized at various production stages of the batch production plan. For example, for a product storage stage, the sensor data 220 may include actual values of different parameters, such as temperature, pressure, humidity, and vibration, sensed by one or more sensor devices equipped within a transportation vehicle used for transporting some or all products within the product batch. In addition, or alternatively, the sensor data 220 may include forecasted values of the parameters.

In operation, a user of an organization, intending to assess recall risk for a product batch produced, to be produced, or being produced by the organization, may issue a recall risk assessment request in relation to the product batch using the user device 204. Upon receiving the recall risk assessment request, the batch risk assessment engine 106 may obtain a batch production plan (BPP) corresponding to the product batch. In an example, the BPP may be obtained from a user associated with the organization. In another example, the BPP may be pre-stored in the database 202 and may be obtained from the database 202. In another example, the BPP may be pre-stored in the memory 212 of the system 100 and may be obtained from the memory 212. The BPP may describe a plurality of production stages involved in production of the product batch. In one example, the BPP may be stored within the BPP data 114. Examples of the plurality of production stages may include, but are not limited to, a raw material sourcing stage, a product manufacturing stage, a product packaging stage, a product storage stage, and a product distribution stage. Further, for each production stage of the plurality of production stages, the BPP may indicate one or more control variables governing one or more performance parameters of the production stage.

For instance, for the raw material sourcing stage, the one or more control variables may include, but are not limited to, raw material specification and raw material supplier specification. For the product manufacturing stage, the one or more control variables may include, but are not limited to, product specification, manufacturing equipment specification, product batch size, environmental conditions, raw material ratios, and product manufacturing process specification. For the product packaging stage, the one or more control variables may include, but are not limited to, packaging material specification, sealing temperature and pressure values, packaging equipment specification, product label information, and product label placement details. For the product storage stage, the one or more control variables may include, but are not limited to, a warehouse address, storage temperature range, light exposure limits, and humidity control settings. For the product distribution stage, the one or more control variables may include, but are not limited to, transportation mode, temperature range during transit, product handling procedure specification, and transportation route.

The one or more performance parameters may be production parameters that are crucial for reducing the recall risk associated with the product batch. The one or more performance parameters of the production stage may be influenced by managing and optimizing the one or more control variables of the production stage. For the raw material sourcing stage, examples of the one or more performance parameters may include, but are not limited to, raw material quality, raw material delay, and supplier issues. For the product manufacturing stage, examples of the one or more performance parameters may include, but are not limited to, product quality, production issues, and contamination issues. For the product packaging stage, example of the one or more performance parameters may include, but is not limited to, packaging defects. For the product storage stage, example of the one or more performance parameters may include, but is not limited to, storage temperature deviations. For the product distribution stage, examples of the one or more performance parameters may include, but are not limited to, production destination issues, transportation delays, shipping steps frequency issues, transportation temperature issues, and location handling issues.

Once the BPP is obtained, for each production stage, the batch risk assessment engine 106 may analyze the one or more control variables governing the production stage to determine a parameter-specific recall risk value corresponding to each of the one or more performance parameters of the production stage. In an example, the one or more control variables may be analyzed using the parameter-specific risk determination model 112. For instance, for the raw material sourcing stage, a first parameter-specific recall risk value may be determined corresponding to the raw material quality, a second parameter-specific recall risk value may be determined corresponding to the raw material delay, and a third parameter-specific recall risk value may be determined corresponding to the supplier issues. Similarly, parameter-specific recall risk values may be determined for the one or more performance parameters of each production stage.

The parameter-specific recall risk value may be a quantitative measure that represents the likelihood of recall of the product batch due to issues or deviations associated with the corresponding performance parameter within the corresponding production stage. The parameter-specific recall risk value may be expressed as a probability or a normalized score between 0 and 1, where higher values may indicate a greater risk of the recall. For instance, if the first parameter-specific recall risk value is determined to be 0.8, there would be 0.8 probability of recall risk associated with manufacturing the product batch utilizing the BPP in the present form, for example, due to poor quality of raw material being received from a particular supplier involved in the BPP in the present form. While the parameter-specific recall risk value has been explained using normalized format, the parameter-specific recall risk value may be expressed using any other scale. In one example, the parameter-specific recall risk values may be stored within the recall risk value data 116.

The performance parameter may be one of a static performance parameter and a dynamic performance parameter. The static performance parameter may be a parameter being governed by control variables for which the sensor data, such as the actual sensor data or the forecasted sensor data, may either not be available or may not be significant for determining the parameter-specific recall risk value. For example, for a static performance parameter “raw material quality”, actual or real-time evaluation of the raw material may not be done, and the parameter-specific recall risk value may be determined using historical quality ratings associated with the raw material. The dynamic performance parameter may be a parameter being governed by control variables for which the sensor data may be significant for determining the parameter-specific recall risk value.

Thus, for determining a parameter-specific recall risk value corresponding to each static performance parameter of the one or more performance parameters, the batch risk assessment engine 106 may obtain historical performance data associated with one or more specific control variables governing the performance parameter. The historical performance data may be obtained using the parameter-specific risk determination model 112. In an example, the historical performance data may be obtained from a user associated with the organization. In another example, the historical performance data may be pre-stored in the database 202 and may be obtained from the database 202. In another example, the historical performance data may be pre-stored in the memory 212 of the system 100 and may be obtained from the memory 212. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the performance parameter for which the parameter-specific recall risk value is to be determined. In one example, the historical performance data may be stored within the historical performance data 218.

Subsequently, the batch risk assessment engine 106 may analyze the historical performance data using the parameter-specific risk determination model 112 to determine the parameter-specific recall risk value corresponding to the performance parameter. For example, quality ratings of raw material historically supplied by a particular supplier selected within the BPP may be analyzed using a first parameter-specific risk determination model, to determine the parameter-specific recall risk value corresponding to the static performance parameter “raw material quality”. The first parameter-specific risk determination model may be specifically trained to determine the parameter-specific recall risk value based on analysis of the quality ratings. Thus, the batch risk assessment engine 106 allows for a data-driven, objective assessment of recall risk for each performance parameter, contributing to a comprehensive understanding of overall recall risk for the product batch.

Further, for determining a parameter-specific recall risk value corresponding to each dynamic performance parameter, the batch risk assessment engine 106 may obtain sensor data associated with one or more sensor devices utilized at the production stage. For example, storage temperature associated with a warehouse utilized at the product storage stage may be obtained. The sensor data may be obtained using the parameter-specific risk determination model 112. In an example, the sensor data may be obtained from a user associated with the organization. In another example, the sensor data may be pre-stored in the database 202 and may be obtained from the database 202. In another example, the sensor data may be pre-stored in the memory 212 of the system 100 and may be obtained from the memory 212. In one example, the sensor data may be stored within the sensor data 220.

The sensor data may include at least one of actual sensor data and forecasted sensor data. The actual sensor data may be obtained from the one or more sensor devices that sense the actual sensor data. Thus, the batch risk assessment engine 106 may receive the actual sensor data from the one or more sensor devices in real-time. For example, the actual sensor data may be received from one or more temperature sensors installed in the warehouse. In addition, or alternatively, the batch risk assessment engine 106 may analyze one or more specific control variables governing the dynamic performance parameter to generate the forecasted sensor data. For example, based on weather forecasting for the date at which the product batch is scheduled to be stored, temperature insulation properties of the warehouse, and historical temperature setting records of the warehouse, the forecasted sensor data may be generated by the batch risk assessment engine 106.

The batch risk assessment engine 106 may further obtain historical performance data associated with the sensor data and the one or more specific control variables governing the performance parameter. The historical performance data may be obtained using the parameter-specific risk determination model 112. In an example, the historical performance data may be obtained from a user associated with the organization. In another example, the historical performance data may be pre-stored in the database 202 and may be obtained from the database 202. In another example, the historical performance data may be pre-stored in the memory 212 of the system 100 and may be obtained from the memory 212. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the performance parameter for which the parameter-specific recall risk value is to be determined. In one example, the historical performance data may be stored within the historical performance data 218.

Once the sensor data and the historical performance data are obtained, the batch risk assessment engine 106 may analyze the sensor data and the historical performance data to determine the parameter-specific recall risk value corresponding to the performance parameter. The sensor data and the historical performance data may be analyzed using the parameter-specific risk determination model 112 and a data assimilation framework, such as a Kalman filter. For example, the sensor data, past temperature insulation properties of the warehouse, and historical temperature setting records of the warehouse may be analyzed using a second parameter-specific risk determination model, to determine the parameter-specific recall risk value corresponding to a dynamic performance parameter “storage temperature deviations”. The second parameter-specific risk determination model may be specifically trained to determine the parameter-specific recall risk value based on analysis of the sensor data, the past temperature insulation properties, and the historical temperature setting records. Thus, the batch risk assessment engine 106 allows for a data-driven, objective assessment of recall risk for each performance parameter, contributing to a comprehensive understanding of overall recall risk for the product batch.

Once the parameter-specific recall risk values are determined for the one or more performance parameters of each production stage, for each production stage, the batch risk assessment engine 106 may aggregate the parameter-specific recall risk values determined for the one or more performance parameters to generate a stage-specific recall risk value for the production stage. Thus, multiple parameter-specific recall risk values may be combined into a single, comprehensive risk value for an entire production stage, taking into account all the performance parameters. In an example, the parameter-specific recall risk values may be aggregated utilizing different statistical methods, such a Bayesian mechanism. The stage-specific recall risk value may be a comprehensive measure that represents the overall likelihood of recall of the product batch due to issues or deviations associated with an entire production stage of the BPP. The stage-specific recall risk value may be expressed as a probability or a normalized score between 0 and 1, where higher values may indicate a greater risk of the recall. In one example, the stage-specific recall risk values generated for the plurality of production stages may be stored within the recall risk value data 116.

The batch risk assessment engine 106 may then aggregate the stage-specific recall risk values generated for the plurality of production stages to generate a global recall risk value associated with manufacturing the product batch utilizing the BPP. In an example, the stage-specific recall risk values may be aggregated utilizing different statistical methods, such a Bayesian mechanism. The global recall risk value may be a comprehensive measure that represents the overall likelihood of recall of the product batch if the product batch is produced using the BPP. The global recall risk value encompasses the recall risks from all production stages and the performance parameters corresponding to the production stage, providing a single, unified risk assessment for the BPP. In an example, the global recall risk value may be recurrently updated during implementation of the BPP. For example, the global recall risk value may be recurrently updated by modifying the parameter-specific recall risk values using the actual sensor data, when available, in place of the forecasted sensor data. In one example, the global recall risk value may be stored within the recall risk value data 116.

The report generation engine 108 may generate a risk assessment report for the product batch for transmission to the user device 204. The risk assessment report may be a structured document containing key information about recall risk assessment for the product batch. The risk assessment report may include the global recall risk value. In one example, the risk assessment report may be stored within the risk assessment report data 118.

A user associated with the organization may access the risk assessment report through the user device 204. Utilizing the risk assessment report, the user may quickly assess recall risk profile of the product batch and make informed decisions about whether to proceed with production as planned or implement modifications to the BPP to reduce the recall risk associated with the product batch.

In an example, the plan optimization engine 216 of the system 100 may be configured to optimize the BPP upon receiving a plan optimization request from the user through the user device 204. The plan optimization engine 216 may receive the plan optimization request from the user device 204. In addition, or alternatively, the plan optimization engine 216 of the system 100 may be configured to optimize the BPP automatically, without any user request, upon determining that the global recall risk value is greater than a desired threshold risk value. In an example, the desired threshold risk value may be included in the plan optimization request. In another example, the desired threshold risk value may be received from the user, post receiving the plan optimization request. In yet another example, the desired threshold risk value may be pre-stored in the memory 212 of the system 100 and may be obtained from the memory 212 for comparison with the global recall risk value.

Upon determining that the global recall risk value is greater than the desired threshold risk value, with or without the plan optimization request, the plan optimization engine 216 may identify at least one candidate performance parameter, from amongst the one or more performance parameters, for improvisation. The at least one candidate performance parameter may be identified for at least one of the plurality of production stages. Further, the plan optimization engine 216 may identify at least one candidate control variable governing the at least one candidate performance parameter. The at least one candidate control variable may be modified to improvise the at least one candidate performance parameter for optimizing the BPP.

In one example, the plan optimization request may include the at least one candidate control variable governing the at least one candidate performance parameter of the one or more performance parameters, to be modified within the BPP. Thus, the plan optimization engine 216 may analyze or process the plan optimization request to identify the at least one candidate performance parameter and the at least one candidate control variable.

In another example, if the plan optimization request does not include the at least one candidate control variable governing the at least one candidate performance parameter or recall risk optimization is being implemented without any plan optimization request, the plan optimization engine 216 may identify the at least one candidate performance parameter and the at least one candidate control variable through a systematic approach. For example, the plan optimization engine 216 may analyze contribution of each performance parameter and each control variable to the global recall risk value and prioritize performance parameters with higher contributions as candidates for improvisation. In another example, the plan optimization engine 216 may perform sensitivity analysis to determine how changes in each performance parameter and each control variable affect the global recall risk value, and identify those performance parameters or control variables as candidates which show a significant impact on recall risk reduction when improvised. In yet another example, the plan optimization engine 216 may use an iterative approach, starting with the most promising candidates and progressively refining selection of the candidates based on the results of initial optimization attempts. In yet another example, the plan optimization engine 216 may assess the estimated cost and effort required to improve each performance parameter and each control variable against the potential recall risk reduction and prioritize performance parameters as the candidates that offer the best recall risk reduction per unit of investment.

Once the at least one candidate control variable is identified, the plan optimization engine 216 may modify the at least one candidate control variable within the BPP to generate an optimized batch production plan (OBPP) for the product batch. The OBPP may have an optimized global recall risk value equal to or lower than the desired threshold risk value. In an example, the OBPP may be generated in response to receiving the plan optimization request. In another example, the OBPP may be generated without receiving any plan optimization request. In an example, the OBPP may be stored within the BPP data 114.

In an example, for modifying the at least one candidate control variable within the BPP to generate the OBPP, the plan optimization engine 216 may determine an alternate control variable corresponding to each of the at least one candidate control variable for optimizing the BPP. For example, an alternate control variable “supplier B” may be determined corresponding to a candidate control variable “supplier A” within the BPP. Further, an alternate control variable “transportation mode B” may be determined corresponding to a candidate control variable “transportation mode A” within the BPP. That is, the plan optimization engine 216 may determine that if “supplier A” is replaced with “supplier B” and “transportation mode A” is replaced with “transportation mode B”, then the global recall risk value may be reduced below the desired threshold risk value.

The plan optimization engine 216 may determine the alternate control variable corresponding to each of the at least one candidate control variable through a systematic approach. For example, the plan optimization engine 216 may analyze each candidate control variable to understand current settings of the candidate control variable, allowable modification possibilities for the candidate control variable, and impact of modifying the candidate control variable on the BPP. The plan optimization engine 216 may balance multiple objectives such as recall risk reduction, product quality improvement, and batch production efficiency to determine an optimal alternate control variable corresponding to the control variable. In case the plan optimization engine 216 does not find any alternate control variable corresponding to any of the at least one candidate control variable, the plan optimization engine 216 may generate an interactive query dialog seeking inputs from the user to modify that particular control variable.

Thus, the plan optimization engine 216 may replace each of the at least one candidate control variable within the BPP with the corresponding alternate control variable to generate the OBPP for the product batch. The OBPP incorporates changes that are specifically designed to reduce the global recall risk value of the product batch, enhancing product safety and quality.

In another example, for modifying the at least one candidate control variable within the BPP to generate the OBPP, the plan optimization engine 216 may obtain a list of pre-stored control variables associated with the at least one candidate performance parameter. For example, a list of raw material suppliers or a list of transportation providers may be obtained. In an example, the list of pre-stored control variables may be obtained from a user associated with the organization. In another example, the list of pre-stored control variables may be pre-stored in the database 202 and may be obtained from the database 202. In another example, the list of pre-stored control variables may be pre-stored in the memory 212 of the system 100 and may be obtained from the memory 212.

Further, the plan optimization engine 216 may ascertain whether any pre-stored control variable, from the list of pre-stored control variables, is plausible to be an alternate control variable corresponding to each of the at least one candidate control variable for optimizing the BPP. For example, an alternate control variable “supplier B” in the list of pre-stored control variables may be determined corresponding to a candidate control variable “supplier A” within the BPP. Further, an alternate control variable “transportation mode B” in the list of pre-stored control variables may be determined corresponding to a candidate control variable “transportation mode A” within the BPP. That is, the plan optimization engine 216 may determine that if “supplier A” is replaced with “supplier B” and “transportation mode A” is replaced with “transportation mode B”, then the global recall risk values may be reduced below the desired threshold risk value. In case the plan optimization engine 216 does not find any alternate control variable corresponding to any of the at least one candidate control variable, the plan optimization engine 216 may generate an interactive query dialog seeking inputs from the user to modify that particular control variable. In addition, or alternatively, the plan optimization engine 216 may generate a notification notifying the user that the list of pre-stored control variables does not include a suitable alternate for that particular control variable. For example, the notification may state that the list of raw material suppliers does not include a suitable alternate to modify the raw material supplier and suggest the user to find another raw material supplier which is not already present in the list of raw material suppliers.

Subsequently, for each candidate control variable ascertained to have a single alternate control variable in the list of pre-stored control variables, the plan optimization engine 216 may replace the candidate control variable within the BPP with the corresponding single alternate control variable, for generating the OBPP.

Further, for each candidate control variable ascertained to have a plurality of alternate control variables in the list of pre-stored control variables, the plan optimization engine 216 may generate an interactive query dialog seeking a user input for selecting a particular alternate control variable from the plurality of alternate control variables. The plan optimization engine 216 may transmit the interactive query dialog to the user device 204. The plan optimization engine 216 may receive a user input specifying the particular alternate control variable, for instance, through the user device 204. The plan optimization engine 216 may then replace the candidate control variable within the BPP with the particular alternate control variable to generate the OBPP for the product batch.

The plan optimization engine 216 may generate a risk optimization report for transmission to the user device 204. The risk optimization report may include the OBPP. The OBPP incorporates changes that are specifically designed to reduce the global recall risk value of the product batch, enhancing product safety and quality. Thus, the present subject matter provides a comprehensive and proactive approach to recall risk management in complex batch production processes by integrating risk assessments from multiple production stages into a unified and accurate global risk profile, enabling informed decision-making and targeted optimization. Further, the present subject matter enables dynamic, data-driven optimization of batch productions plans by identifying and modifying control variables across multiple production stages, thereby minimizing recall risks of product batches.

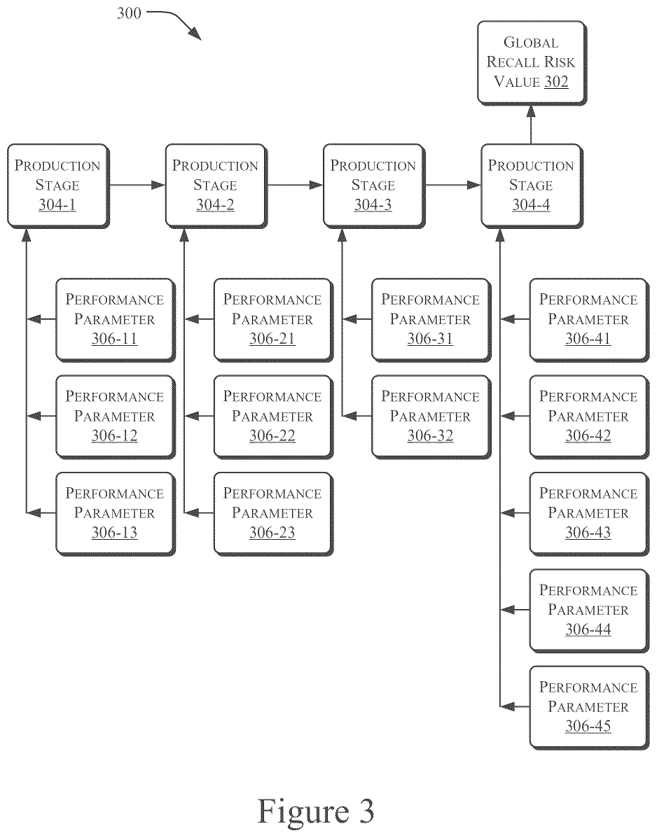

FIG. 3 illustrates a block diagram depicting an exemplary two-dimensional (2D) chain 300 for determining a global recall risk value 302 associated with a product batch, according to an example. The number of components in the 2D chain 300 and the order in which the 2D chain 300 is described are not intended to be construed as a limitation, and some of the described components of the 2D chain 300 may be combined in a different order to determine the global recall risk value 302 according to the 2D chain 300 or an alternative 2D chain.

The 2D chain 300 includes a first production stage 304-1, a second production stage 304-2, a third production stage 304-3, and a fourth production stage 304-4. For example, the first production stage 304-1 may be a raw material sourcing stage, the second production stage 304-2 may be a product manufacturing stage, the third production stage 304-3 may be a product packaging and storage stage, and the fourth production stage 304-4 may be a product distribution stage. The combination of the first production stage 304-1, the second production stage 304-2, the third production stage 304-3, and the fourth production stage 304-4 may hereinafter be alternatively referred to as the production stages 304. The production stages 304 may be described by a batch production plan (BPP) corresponding to the product batch for which the global recall risk value 302 is to be computed. Although four production stages 304 have been illustrated in the 2D chain 300, it should be understood to a person skilled in the art that the BPP may describe any number (equal to or greater than 1) of production stages corresponding to the product batch for use in the 2D chain 300 for determining the global recall risk value 302.

The 2D chain 300 includes one or more performance parameters corresponding to each of the production stages 304. For instance, the 2D chain 300 includes a first performance parameter 306-11 such as raw material quality, a second performance parameter 306-12 such as raw material delay, and a third performance parameter 306-13 such as supplier issues, corresponding to the first production stage 304-1. Further, the 2D chain 300 includes a first performance parameter 306-21 such as product quality, a second performance parameter 306-22 such as production issues, and a third performance parameter 306-23 such as contamination issues, corresponding to the second production stage 304-2. Further, the 2D chain 300 includes a first performance parameter 306-31 such as packaging defects and a second performance parameter 306-32 such as storage temperature deviations, corresponding to the third production stage 304-3. Furthermore, the 2D chain 300 includes a first performance parameter 306-41 such as production destination issues, a second performance parameter 306-42 such as transportation delays, a third performance parameter 306-43 such as shipping steps frequency issues, a fourth performance parameter 306-44 such as transportation temperature issues, and a fifth performance parameter 306-45 such as location handling issues, corresponding to the fourth production stage 304-4.

The combination of the first performance parameter 306-11, the second performance parameter 306-12, and the third performance parameter 306-13 corresponding to the first production stage 304-1 may hereinafter be alternatively referred to as the performance parameters 306-1. The combination of the first performance parameter 306-21, the second performance parameter 306-22, and the third performance parameter 306-23 corresponding to the second production stage 304-2 may hereinafter be alternatively referred to as the performance parameters 306-2. The combination of the first performance parameter 306-31 and the second performance parameter 306-32 corresponding to the third production stage 304-3 may hereinafter be alternatively referred to as the performance parameters 306-3. The combination of the first performance parameter 306-41, the second performance parameter 306-42, the third performance parameter 306-43, the fourth performance parameter 306-44, and the fifth performance parameter 306-45 corresponding to the fourth production stage 304-4 may hereinafter be alternatively referred to as the performance parameters 306-4. The combination of the performance parameters 306-1, 306-2, 306-3, and 306-4 may hereinafter be alternatively referred to as the performance parameters 306.

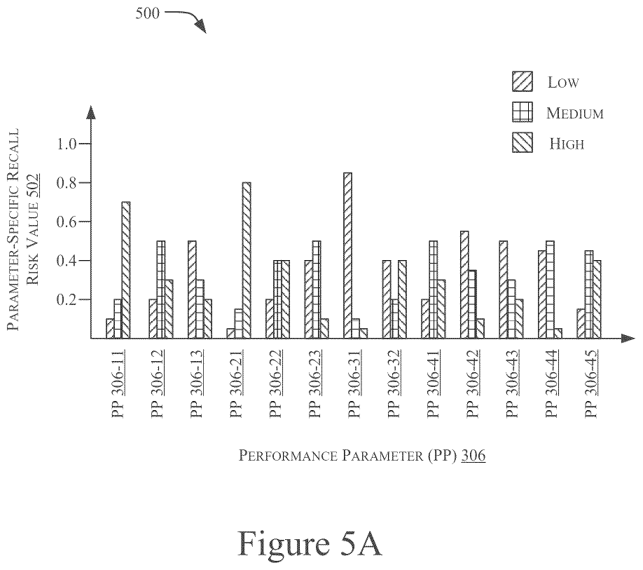

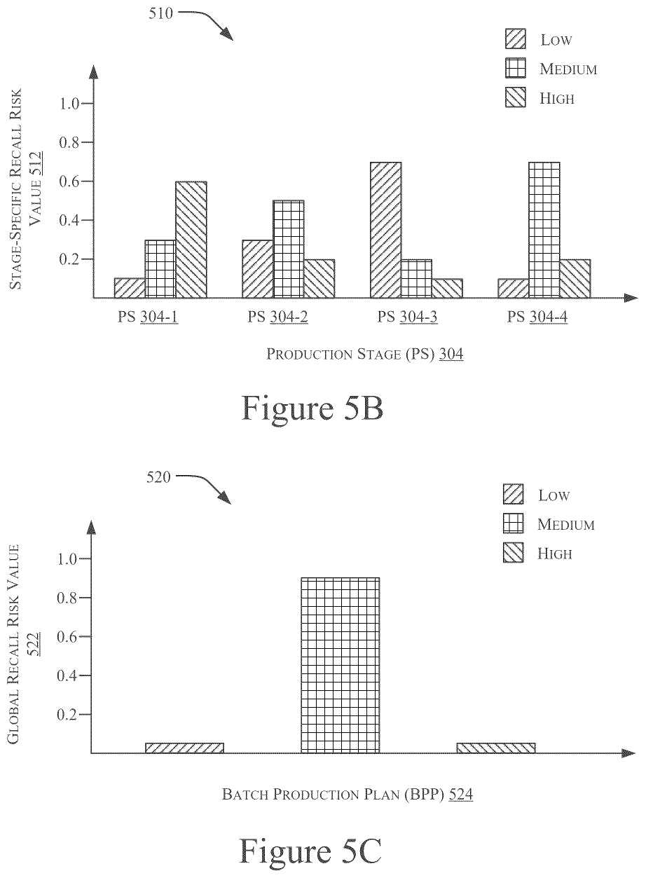

For determining the global recall risk value 302 corresponding to the product batch, a parameter-specific recall risk value is determined corresponding to each performance parameter of the performance parameters 306. The parameter-specific recall risk value may be a quantitative measure that represents the likelihood of recall of the product batch due to issues or deviations associated with the corresponding performance parameter within the corresponding production stage. For instance, a parameter-specific recall risk value corresponding to the first performance parameter 306-11 may be a quantitative measure that represents the likelihood of recall of the product batch due to issues or deviations associated with the raw material quality at the raw material sourcing stage. Exemplary parameter-specific recall risk values are determined corresponding to each performance parameter of the performance parameters 306 have been illustrated in FIG. 5A.

For each production stage of the production stages 304, parameter-specific recall risk values determined for the performance parameters corresponding to production stage may be aggregated to generate a stage-specific recall risk value for the production stage. In an example, the parameter-specific recall risk values may be aggregated utilizing different statistical methods, such a Bayesian mechanism. The stage-specific recall risk value may be a comprehensive measure that represents the overall likelihood of recall of the product batch due to issues or deviations associated with an entire production stage of the BPP. For instance, parameter-specific recall risk values determined for the performance parameters 306-1 may be aggregated to generate a stage-specific recall risk value for the first production stage 304-1. Similarly, parameter-specific recall risk values determined for the performance parameters 306-2 may be aggregated to generate a stage-specific recall risk value for the second production stage 304-2. Further, parameter-specific recall risk values determined for the performance parameters 306-3 may be aggregated to generate a stage-specific recall risk value for the third production stage 304-3. Furthermore, parameter-specific recall risk values determined for the performance parameters 306-4 may be aggregated to generate a stage-specific recall risk value for the fourth production stage 304-4. Thus, parameter-specific recall risk values are aggregated vertically to generate stage-specific recall risk values for the production stages 304. Exemplary stage-specific recall risk values generated for the production stages 304 have been illustrated in FIG. 5B.

Then, the stage-specific recall risk values generated for the production stages 304 may be aggregated to generate the global recall risk value 302 associated with manufacturing the product batch utilizing the BPP. Thus, stage-specific recall risk values are aggregated horizontally to generate the global recall risk value 302. The vertical and horizontal aggregation of recall risk values form the 2D chain 300 for determining the global recall risk value 302. In an example, the stage-specific recall risk values may be aggregated utilizing different statistical methods, such a Bayesian mechanism. Exemplary global recall risk value associated with manufacturing the product batch utilizing the BPP has been illustrated in FIG. 5C. The global recall risk value 302 may be a comprehensive measure that represents the overall likelihood of recall of the product batch if the product batch is produced using the BPP.

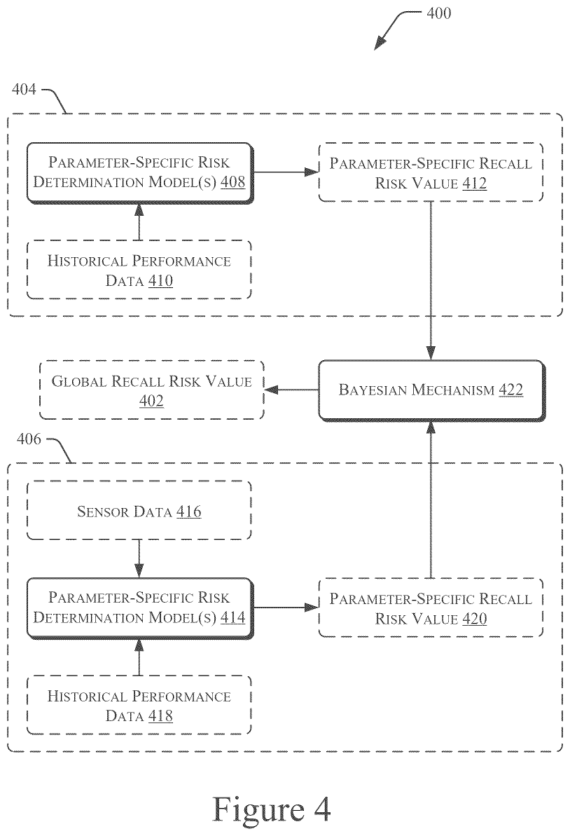

FIG. 4 illustrates a block diagram depicting an exemplary data flow 400 for determining a global recall risk value 402 associated with a product batch, according to another example. The order in which the data flow 400 is described is not intended to be construed as a limitation, and some of the described components of the data flow 400 may be combined in a different order to implement a data flow according to the data flow 400, or an alternative data flow.

The block diagram includes a first recall risk prediction block 404 and a second recall risk prediction block 406. The first recall risk prediction block 404 may be configured to determine a parameter-specific recall risk value corresponding to each static performance parameter of one or more performance parameters, say the performance parameters 306-1, 306-2, 306-2, and 306-4, corresponding to each production stage, say the production stages 304, described by a batch production plan (BPP). The static performance parameter may be a parameter being governed by control variables for which actual or real-time evaluation, such as using sensor devices, may either not be available or may not be significant for determining the parameter-specific recall risk value. For example, for a static performance parameter “raw material quality”, actual or real-time evaluation of the raw material may not be done, and the parameter-specific recall risk value may be determined using historical quality ratings associated with the raw material.

Further, the second recall risk prediction block 406 may be configured to determine a parameter-specific recall risk value corresponding to each dynamic performance parameter of the one or more performance parameters corresponding to each of the production stages described by the BPP. The dynamic performance parameter may be a parameter being governed by control variables for which actual or real-time evaluation, such as using sensor devices, may be significant for determining the parameter-specific recall risk value.

According to the data flow 400, at the first recall risk prediction block 404, for each static performance parameter, a parameter-specific risk determination model 408, say the parameter-specific risk determination model 112, may obtain historical performance data 410 associated with one or more specific control variables governing the static performance parameter. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the static performance parameter for which the parameter-specific recall risk value is to be determined.

Subsequently, the parameter-specific risk determination model 408 may analyze the historical performance data 410 to determine a parameter-specific recall risk value 412 corresponding to the static performance parameter. For example, quality ratings of raw material historically supplied by a particular supplier selected within the BPP may be analyzed using the parameter-specific risk determination model 408 to determine the parameter-specific recall risk value 412 corresponding to the static performance parameter “raw material quality”. The parameter-specific risk determination model 408 may be specifically trained to determine the parameter-specific recall risk value 412 based on analysis of the quality ratings. In an example, a different parameter-specific risk determination model may be trained for each static performance parameter.

According to the data flow 400, at the second recall risk prediction block 406, for each dynamic performance parameter, a parameter-specific risk determination model 414, say the parameter-specific risk determination model 112, may obtain sensor data 416 associated with one or more sensor devices utilized at a production stage to which the dynamic performance parameter corresponds. For example, storage temperature associated with a warehouse utilized at a product storage stage may be obtained. The sensor data 416 may include at least one of actual sensor data and forecasted sensor data. The actual sensor data may be obtained from the one or more sensor devices that sense the actual sensor data. For example, the actual sensor data may be received from one or more temperature sensors installed in the warehouse. In addition, or alternatively, the forecasted sensor data may be generated based on analysis of one or more specific control variables governing the dynamic performance parameter. For example, the forecasted sensor data may be generated based on analysis of weather forecasting for the date at which the product batch is scheduled to be stored, temperature insulation properties of the warehouse, and historical temperature setting records of the warehouse.

The parameter-specific risk determination model 414 may further obtain historical performance data 418 associated with the sensor data 416 and the one or more specific control variables governing the dynamic performance parameter. Examples of the historical performance data 418 may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data 418 is specific to the dynamic performance parameter for which the parameter-specific recall risk value is to be determined.

Subsequently, the parameter-specific risk determination model 414 may analyze the sensor data 416 and the historical performance data 418 to determine a parameter-specific recall risk value 420 corresponding to the dynamic performance parameter. The parameter-specific risk determination model 414 may utilize a data assimilation framework, such as a Kalman filter, for analyzing the sensor data 416 and the historical performance data 418. For example, the sensor data 416, past temperature insulation properties of the warehouse, and historical temperature setting records of the warehouse may be analyzed to determine the parameter-specific recall risk value 420 corresponding to a dynamic performance parameter “storage temperature deviations”. The parameter-specific risk determination model 414 may be specifically trained to determine the parameter-specific recall risk value 420 based on analysis of the quality ratings. In an example, a different parameter-specific risk determination model may be trained for each dynamic performance parameter.

Once the parameter-specific recall risk values are determined for the one or more performance parameters of each production stage, for each production stage, a statistical method such as a Bayesian mechanism 422 may be utilized to aggregate the parameter-specific recall risk values determined for the one or more performance parameters to generate a stage-specific recall risk value for the production stage. Thereafter, the Bayesian mechanism 422 may be utilized to aggregate stage-specific recall risk values generated for a plurality of production stages of the BPP to generate the global recall risk value 402 associated with manufacturing the product batch utilizing the BPP. The global recall risk value 402 may be a comprehensive measure that represents the overall likelihood of recall of the product batch if the product batch is produced using the BPP.

FIGS. 5A to 5C illustrate exemplary graphs 500, 510, and 520 of recall risk values assessed for a product batch by the system 100, according to an example. The way in which the recall risk values are expressed in the graphs 500, 510, and 520 is not intended to be construed as a limitation, and the recall risk values may be expressed using a different scale to substantiate the risk of recall associated with manufacturing the product batch utilizing a particular batch production plan (BPP).

FIG. 5A illustrates a graph 500 of exemplary parameter-specific recall risk values 502 determined by the system 100 corresponding to each performance parameter of the performance parameters 306 described in FIG. 3. The Y-axis of the graph 500 denotes the parameter-specific recall risk values 502 and the X-axis of the graph 500 denotes the performance parameters 306. The system 100 may determine probability of a low recall risk, probability of a medium recall risk, and probability of a high recall risk for each performance parameter. In an example, the probabilities of the low recall risk, the medium recall risk, and the high recall risk are together referred to as a parameter-specific recall risk value corresponding to a performance parameter.

For each performance parameter, the total sum of the probabilities of the low recall risk, the medium recall risk, and the high recall risk is 1. For instance, according to the graph 500, for the first performance parameter 306-11, the probability of the low recall risk is 0.1, the probability of the medium recall risk is 0.2, and the probability of the high recall risk is 0.7. According to the graph 500, for the second performance parameter 306-12, the probability of the low recall risk is 0.2, the probability of the medium recall risk is 0.5, and the probability of the high recall risk is 0.3. For the third performance parameter 306-13, the probability of the low recall risk is 0.5, the probability of the medium recall risk is 0.3, and the probability of the high recall risk is 0.2.

According to the graph 500, for the first performance parameter 306-21, the probability of the low recall risk is 0.05, the probability of the medium recall risk is 0.15, and the probability of the high recall risk is 0.8. For the second performance parameter 306-22, the probability of the low recall risk is 0.2, the probability of the medium recall risk is 0.4, and the probability of the high recall risk is 0.4. For the third performance parameter 306-23, the probability of the low recall risk is 0.4, the probability of the medium recall risk is 0.5, and the probability of the high recall risk is 0.1.

According to the graph 500, for the first performance parameter 306-31, the probability of the low recall risk is 0.85, the probability of the medium recall risk is 0.1, and the probability of the high recall risk is 0.05. For the second performance parameter 306-32, the probability of the low recall risk is 0.4, the probability of the medium recall risk is 0.2, and the probability of the high recall risk is 0.4.

According to the graph 500, for the first performance parameter 306-41, the probability of the low recall risk is 0.2, the probability of the medium recall risk is 0.5, and the probability of the high recall risk is 0.3. For the second performance parameter 306-42, the probability of the low recall risk is 0.55, the probability of the medium recall risk is 0.35, and the probability of the high recall risk is 0.1. For the third performance parameter 306-43, the probability of the low recall risk is 0.5, the probability of the medium recall risk is 0.3, and the probability of the high recall risk is 0.2. For the fourth performance parameter 306-44, the probability of the low recall risk is 0.45, the probability of the medium recall risk is 0.5, and the probability of the high recall risk is 0.05. For the fifth performance parameter 306-45, the probability of the low recall risk is 0.15, the probability of the medium recall risk is 0.45, and the probability of the high recall risk is 0.4.

FIG. 5B illustrates a graph 510 of exemplary stage-specific recall risk values 512 determined by the system 100 corresponding to each production stage of the production stages 304 described in FIG. 3. The Y-axis of the graph 510 denotes the stage-specific recall risk values 512 and the X-axis of the graph 510 denotes the production stages 304. The system 100 may determine probability of a low recall risk, probability of a medium recall risk, and probability of a high recall risk for each production stage. In an example, the probabilities of the low recall risk, the medium recall risk, and the high recall risk are together referred to as a stage-specific recall risk value corresponding to a production stage.

For each production stage, the total sum of the probabilities of the low recall risk, the medium recall risk, and the high recall risk is 1. For instance, according to the graph 510, for the first production stage 304-1, the probability of the low recall risk is 0.1, the probability of the medium recall risk is 0.3, and the probability of the high recall risk is 0.6. For the second production stage 304-2, the probability of the low recall risk is 0.3, the probability of the medium recall risk is 0.5, and the probability of the high recall risk is 0.2.

For the third production stage 304-3, the probability of the low recall risk is 0.7, the probability of the medium recall risk is 0.2, and the probability of the high recall risk is 0.1. For the fourth production stage 304-4, the probability of the low recall risk is 0.1, the probability of the medium recall risk is 0.7, and the probability of the high recall risk is 0.2.

FIG. 5C illustrates a graph 520 of exemplary global recall risk value 522, generated by the system 100, associated with manufacturing a product batch utilizing a batch production plan (BPP) 524. The Y-axis of the graph 520 denotes the global recall risk value 522 and the X-axis of the graph 520 denotes the batch production plan 524 considering which the global recall risk value is generated by the system 100. The system 100 may generate probability of a low recall risk, probability of a medium recall risk, and probability of a high recall risk considering manufacturing of a product batch utilizing the BPP 524. In an example, the probabilities of the low recall risk, the medium recall risk, and the high recall risk are together referred to as a global recall risk value associated with manufacturing a product batch utilizing a BPP.

The total sum of the probabilities of the low recall risk, the medium recall risk, and the high recall risk of the global recall risk value 522 is 1. For instance, according to the graph 510, the probability of the low recall risk is 0.05, the probability of the medium recall risk is 0.9, and the probability of the high recall risk is 0.05.

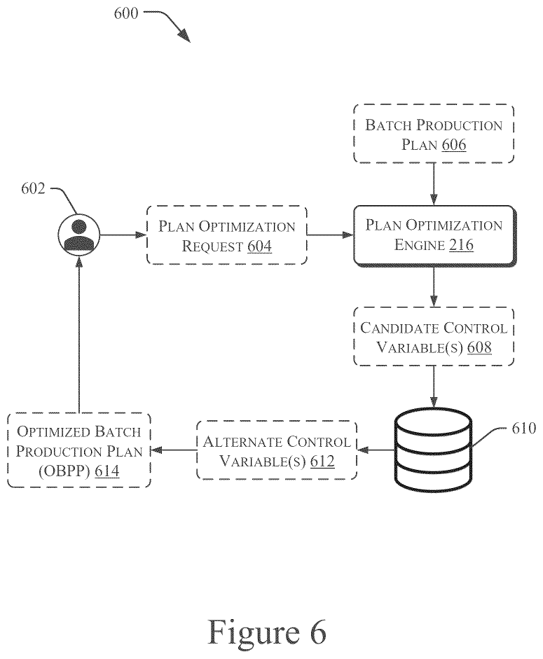

FIG. 6 illustrates a schematic diagram depicting an exemplary data flow 600 for optimizing recall risk associated with a product batch, according to an example. The order in which the data flow 600 is described is not intended to be construed as a limitation, and some of the described components of the data flow 600 may be combined in a different order to implement a data flow according to the data flow 600, or an alternative data flow.

According to the data flow 600, a user 602 may issue a plan optimization request 604 to trigger optimization of a batch production plan (BPP) 606 corresponding to a product batch. The user 602 may issue the plan optimization request 604 through a user device, say the user device 204. The plan optimization engine 216 of the system 100 may receive the plan optimization request 604.

Upon receiving the plan optimization request, the plan optimization engine 216 may obtain the BPP 606. The BPP 606 may describe a plurality of production stages involved in production of the product batch. Further, for each production stage of the plurality of production stages, the BPP 606 may indicate one or more control variables governing one or more performance parameters of the production stage.

The plan optimization engine 216 may analyze the BPP, the plan optimization request 604, and other relevant data to identify at least one candidate performance parameter, from amongst the one or more performance parameters, for improvisation. The at least one candidate performance parameter may be identified for at least one of the plurality of production stages. Further, the plan optimization engine 216 may identify candidate control variable(s) 608 governing the at least one candidate performance parameter. The candidate control variable(s) 608 may be modified to improvise the at least one candidate performance parameter for optimizing the BPP.

In one example, the plan optimization request 604 may include a desired threshold risk value and the candidate control variable(s) 608 governing the at least one candidate performance parameter of the one or more performance parameters, to be modified within the BPP. Thus, the plan optimization engine 216 may analyze or process the plan optimization request 604 to identify the at least one candidate performance parameter and the candidate control variable(s) 608.

In another example, if the plan optimization request 604 does not include the candidate control variable(s) 608 governing the at least one candidate performance parameter, the plan optimization engine 216 may identify the at least one candidate performance parameter and the candidate control variable(s) 608 through a systematic approach. For example, the plan optimization engine 216 may analyze contribution of each performance parameter and each control variable to a global recall risk value, say the global recall risk value 302, 402, and 522, associated with manufacturing the product batch using the BPP 606 in the present form. The plan optimization engine 216 may then prioritize performance parameters with higher contributions as candidates for improvisation. In another example, the plan optimization engine 216 may perform sensitivity analysis to determine how changes in each performance parameter and each control variable affect the global recall risk value, and identify those performance parameters or control variables as candidates which show a significant impact on recall risk reduction when improvised. In yet another example, the plan optimization engine 216 may use an iterative approach, starting with the most promising candidates and progressively refining selection of the candidates based on the results of initial optimization attempts. In yet another example, the plan optimization engine 216 may assess the estimated cost and effort required to improve each performance parameter and each control variable against the potential recall risk reduction and prioritize performance parameters as the candidates that offer the best recall risk reduction per unit of investment.

Once the candidate control variable(s) are identified, the plan optimization engine 216 may determine alternate control variable(s) 610 corresponding to the candidate control variable(s) 608 for optimizing the BPP. For example, an alternate control variable “supplier B” may be determined corresponding to a candidate control variable “supplier A” within the BPP. Further, an alternate control variable “transportation mode B” may be determined corresponding to a candidate control variable “transportation mode A” within the BPP. That is, the plan optimization engine 216 may determine that if “supplier A” is replaced with “supplier B” and “transportation mode A” is replaced with “transportation mode B”, then the global recall risk value may be reduced below the desired threshold risk value.

For determining the alternate control variable(s) 610, the plan optimization engine 216 may query a database 612. The database 612 may store a list of pre-stored control variables. For example, the database 612 may store a list of raw material suppliers or a list of transportation providers. The plan optimization engine 216 may ascertain whether any pre-stored control variable, from the list of pre-stored control variables, may be used as alternate control variable(s) 610 corresponding to the candidate control variable(s) 608 for optimizing the BPP.

Thus, the plan optimization engine 216 may replace the candidate control variable(s) 608 within the BPP with the alternate control variable(s) 610 to generate an optimized batch production plan (OBPP) 614 for the product batch. The OBPP 614 may have an optimized global recall risk value equal to or lower than the desired threshold risk value specified by the user 602. The OBPP 614 may then be provided to the user, for instance, through the user device.

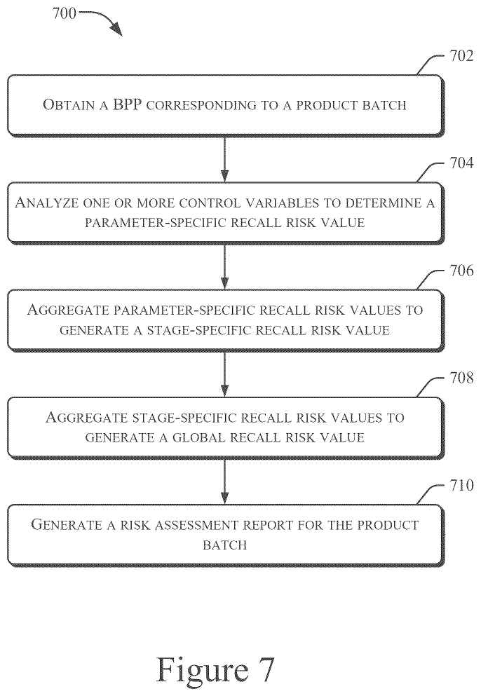

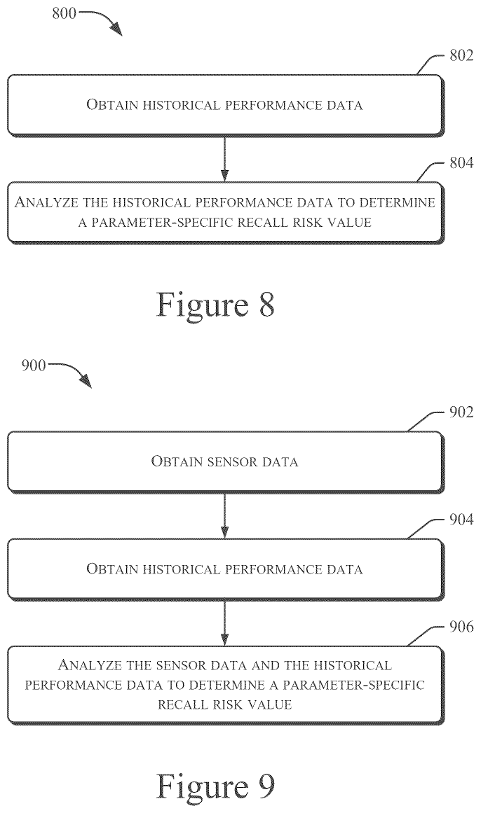

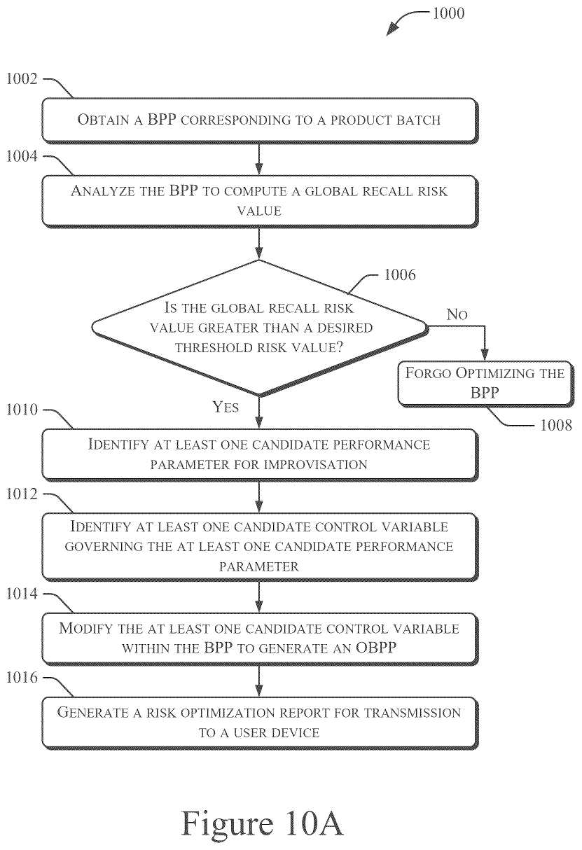

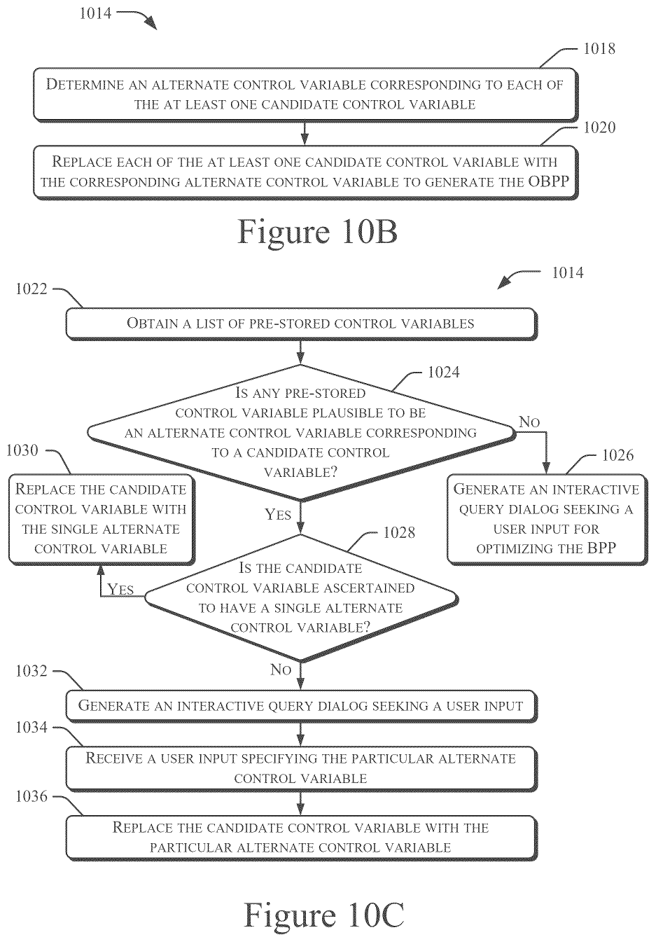

FIG. 7, FIG. 8, FIG. 9, FIG. 10A, FIG. 10B, and FIG. 10C, illustrate example methods 700, 800, 900, 1000, 1014, and 1014, respectively, for assessing and optimizing recall risk associated with a product batch. The order in which the methods are described is not intended to be construed as a limitation, and any number of the described method blocks may be combined in any order to implement the methods, or an alternative method. Further, the methods 700, 800, 900, 1000, and 1014 may be implemented by processing resource or computing device(s) through any suitable hardware, non-transitory machine-readable instructions, or combination thereof.

It may also be understood that methods 700, 800, 900, 1000, and 1014 may be performed by programmed computing devices, such as the system 100, as depicted in FIG. 1 and FIG. 2. Furthermore, the methods 700, 800, 900, 1000, and 1014 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 700, 800, 900, 1000, and 1014 are described below with reference to the system 100 as described above; other suitable systems for the execution of these methods may also be utilized. Additionally, implementation of the methods 700, 800, 900, 1000, and 1014 is not limited to such examples.

FIG. 7 illustrates the method 700 for assessing recall risk associated with a product batch, according to an example.

At block 702, a batch production plan (BPP) corresponding to the product batch may be obtained. In an example, the BPP may be obtained from a user associated with the organization. In another example, the BPP may be pre-stored in a memory, say the memory 212, of the system 100 and may be obtained from the memory. The BPP may describe a plurality of production stages involved in production of the product batch. Examples of the plurality of production stages may include, but are not limited to, a raw material sourcing stage, a product manufacturing stage, a product packaging stage, a product storage stage, and a product distribution stage. Further, for each production stage of the plurality of production stages, the BPP may indicate one or more control variables governing one or more performance parameters of the production stage.

For instance, for the raw material sourcing stage, the one or more control variables may include, but are not limited to, raw material specification and raw material supplier specification. For the product manufacturing stage, the one or more control variables may include, but are not limited to, product specification, manufacturing equipment specification, product batch size, environmental conditions, raw material ratios, and product manufacturing process specification. For the product packaging stage, the one or more control variables may include, but are not limited to, packaging material specification, sealing temperature and pressure values, packaging equipment specification, product label information, and product label placement details. For the product storage stage, the one or more control variables may include, but are not limited to, a warehouse address, storage temperature range, light exposure limits, and humidity control settings. For the product distribution stage, the one or more control variables may include, but are not limited to, transportation mode, temperature range during transit, product handling procedure specification, and transportation route.

The one or more performance parameters may be production parameters that are crucial for reducing the recall risk associated with the product batch. The one or more performance parameters of the production stage may be influenced by managing and optimizing the one or more control variables of the production stage. For the raw material sourcing stage, examples of the one or more performance parameters may include, but are not limited to, raw material quality, raw material delay, and supplier issues. For the product manufacturing stage, examples of the one or more performance parameters may include, but are not limited to, product quality, production issues, and contamination issues. For the product packaging stage, example of the one or more performance parameters may include, but is not limited to, packaging defects. For the product storage stage, example of the one or more performance parameters may include, but is not limited to, storage temperature deviations. For the product distribution stage, examples of the one or more performance parameters may include, but are not limited to, production destination issues, transportation delays, shipping steps frequency issues, transportation temperature issues, and location handling issues.

At block 704, for each production stage, the one or more control variables governing the production stage may be analyzed to determine a parameter-specific recall risk value corresponding to each of the one or more performance parameters of the production stage. In an example, the one or more control variables may be analyzed using a parameter-specific risk determination model, say the parameter-specific risk determination model 112. For instance, for the raw material sourcing stage, a first parameter-specific recall risk value may be determined corresponding to the raw material quality, a second parameter-specific recall risk value may be determined corresponding to the raw material delay, and a third parameter-specific recall risk value may be determined corresponding to the supplier issues. Similarly, parameter-specific recall risk values may be determined for the one or more performance parameters of each production stage. The parameter-specific recall risk value may be a quantitative measure that represents the likelihood of recall of the product batch due to issues or deviations associated with the corresponding performance parameter within the corresponding production stage.

At block 706, for each production stage, parameter-specific recall risk values determined for the one or more performance parameters may be aggregated to generate a stage-specific recall risk value for the production stage. Thus, multiple parameter-specific recall risk values may be combined into a single, comprehensive risk value for an entire production stage, taking into account all the performance parameters. In an example, the parameter-specific recall risk values may be aggregated utilizing different statistical methods, such a Bayesian mechanism. The stage-specific recall risk value may be a comprehensive measure that represents the overall likelihood of recall of the product batch due to issues or deviations associated with an entire production stage of the BPP.

At block 708, stage-specific recall risk values generated for the plurality of production stages may be aggregated to generate a global recall risk value associated with manufacturing the product batch utilizing the BPP. In an example, the stage-specific recall risk values may be aggregated utilizing different statistical methods, such a Bayesian mechanism. The global recall risk value may be a comprehensive measure that represents the overall likelihood of recall of the product batch if the product batch is produced using the BPP. The global recall risk value encompasses the recall risks from all production stages and the performance parameters corresponding to the production stage, providing a single, unified risk assessment for the BPP.

At block 710, a risk assessment report may be generated for the product batch for transmission to a user device. Examples of the user device may include, but are not limited to, a desktop computer, a laptop, a tablet, a smartphone, and a wearable device. The risk assessment report may be a structured document containing key information about recall risk assessment for the product batch. The risk assessment report may include the global recall risk value. A user associated with the organization may access the risk assessment report through the user device. Utilizing the risk assessment report, the user may quickly assess recall risk profile of the product batch and make informed decisions about whether to proceed with production as planned or implement modifications to the BPP to reduce the recall risk associated with the product batch. Thus, the present subject matter provides a streamlined approach to risk assessment and decision-making, leading to improved product quality, reduced batch recall incidents, and more efficient manufacturing processes.

FIG. 8 illustrates the method 800 for determining parameter-specific recall risk values for assessing recall risk associated with a product batch, according to an example. The method 800 is specifically for determining a parameter-specific recall risk value corresponding to each static performance parameter of one or more performance parameters, say the performance parameters 306-1, 306-2, 306-2, and 306-4, corresponding to each production stage, say the production stages 304, described by a batch production plan (BPP). The static performance parameter may be a parameter being governed by control variables for which actual or real-time evaluation, such as using sensor devices, may either not be available or may not be significant for determining the parameter-specific recall risk value. For example, for a static performance parameter “raw material quality”, actual or real-time evaluation of the raw material may not be done, and the parameter-specific recall risk value may be determined using historical quality ratings associated with the raw material.

At block 802, historical performance data associated with one or more specific control variables governing the static performance parameter may be obtained. The historical performance data may be obtained using a parameter-specific risk determination model, say the parameter-specific risk determination model 112. In an example, the historical performance data may be obtained from a user associated with the organization. In another example, the historical performance data may be pre-stored in a database, say the database 202, and may be obtained from the database. In another example, the historical performance data may be pre-stored in a memory, say the memory 212, of the system 100 and may be obtained from the memory. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the static performance parameter for which the parameter-specific recall risk value is to be determined.

At block 804, the historical performance data may be analyzed using the parameter-specific risk determination model to determine the parameter-specific recall risk value corresponding to the performance parameter. For example, quality ratings of raw material historically supplied by a particular supplier selected within the BPP may be analyzed using a first parameter-specific risk determination model, to determine the parameter-specific recall risk value corresponding to the static performance parameter “raw material quality”. The first parameter-specific risk determination model may be specifically trained to determine the parameter-specific recall risk value based on analysis of the quality ratings.

FIG. 9 illustrates the method 900 for determining parameter-specific recall risk values for assessing recall risk associated with a product batch, according to an example. The method 900 is specifically for determining a parameter-specific recall risk value corresponding to each dynamic performance parameter of one or more performance parameters, say the performance parameters 306-1, 306-2, 306-2, and 306-4, corresponding to each production stage, say the production stages 304, described by a batch production plan (BPP). The dynamic performance parameter may be a parameter being governed by control variables for which actual or real-time evaluation, such as using sensor devices, may be significant for determining the parameter-specific recall risk value.

At block 902, sensor data associated with one or more sensor devices utilized at a production stage to which the dynamic performance parameter corresponds may be obtained using a parameter-specific risk determination model, say the parameter-specific risk determination model 112. For example, storage temperature associated with a warehouse utilized at a product storage stage may be obtained. The sensor data may include at least one of actual sensor data and forecasted sensor data. The actual sensor data may be obtained from the one or more sensor devices that sense the actual sensor data. For example, the actual sensor data may be received from one or more temperature sensors installed in the warehouse. In addition, or alternatively, the forecasted sensor data may be generated based on analysis of one or more specific control variables governing the dynamic performance parameter. For example, the forecasted sensor data may be generated based on analysis of weather forecasting for the date at which the product batch is scheduled to be stored, temperature insulation properties of the warehouse, and historical temperature setting records of the warehouse.

At block 904, historical performance data associated with the sensor data and the one or more specific control variables governing the dynamic performance parameter may be obtained using the parameter-specific risk determination model. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the dynamic performance parameter for which the parameter-specific recall risk value is to be determined.

At block 906, the sensor data and the historical performance data may be analyzed using the parameter-specific risk determination model to determine a parameter-specific recall risk value corresponding to the dynamic performance parameter. The parameter-specific risk determination model may utilize a data assimilation framework, such as a Kalman filter, for analyzing the sensor data and the historical performance data. For example, the sensor data, past temperature insulation properties of the warehouse, and historical temperature setting records of the warehouse may be analyzed to determine the parameter-specific recall risk value corresponding to a dynamic performance parameter “storage temperature deviations”. The parameter-specific risk determination model may be specifically trained to determine the parameter-specific recall risk value based on analysis of the quality ratings. In an example, a different parameter-specific risk determination model may be trained for each dynamic performance parameter.

FIG. 10A illustrates the method 1000 for optimizing recall risk associated with a product batch, according to an example.

At block 1002, a batch production plan (BPP) corresponding to the product batch may be obtained. In an example, the BPP may be obtained from a user associated with the organization. In another example, the BPP may be pre-stored in a memory, say the memory 212, of the system 100 and may be obtained from the memory. The BPP may describe a plurality of production stages involved in production of the product batch. Examples of the plurality of production stages may include, but are not limited to, a raw material sourcing stage, a product manufacturing stage, a product packaging stage, a product storage stage, and a product distribution stage. Further, for each production stage of the plurality of production stages, the BPP may indicate one or more control variables governing one or more performance parameters of the production stage.

For instance, for the raw material sourcing stage, the one or more control variables may include, but are not limited to, raw material specification and raw material supplier specification. For the product manufacturing stage, the one or more control variables may include, but are not limited to, product specification, manufacturing equipment specification, product batch size, environmental conditions, raw material ratios, and product manufacturing process specification. For the product packaging stage, the one or more control variables may include, but are not limited to, packaging material specification, sealing temperature and pressure values, packaging equipment specification, product label information, and product label placement details. For the product storage stage, the one or more control variables may include, but are not limited to, a warehouse address, storage temperature range, light exposure limits, and humidity control settings. For the product distribution stage, the one or more control variables may include, but are not limited to, transportation mode, temperature range during transit, product handling procedure specification, and transportation route.

The one or more performance parameters may be production parameters that are crucial for reducing the recall risk associated with the product batch. The one or more performance parameters of the production stage may be influenced by managing and optimizing the one or more control variables of the production stage. For the raw material sourcing stage, examples of the one or more performance parameters may include, but are not limited to, raw material quality, raw material delay, and supplier issues. For the product manufacturing stage, examples of the one or more performance parameters may include, but are not limited to, product quality, production issues, and contamination issues. For the product packaging stage, example of the one or more performance parameters may include, but is not limited to, packaging defects. For the product storage stage, example of the one or more performance parameters may include, but is not limited to, storage temperature deviations. For the product distribution stage, examples of the one or more performance parameters may include, but are not limited to, production destination issues, transportation delays, shipping steps frequency issues, transportation temperature issues, and location handling issues.

At block 1004, the BPP may be analyzed to compute a global recall risk value associated with manufacturing the product batch utilizing the BPP. The global recall risk value may be recurrently updated during implementation of the BPP. For example, the global recall risk value may be recurrently updated by modifying parameter-specific recall risk values using actual sensor data, when available, in place of forecasted sensor data which was previously used by the system 100 to determine the parameter-specific recall risk values. In one example, the global recall risk value may be computed using the method 700.

In an example, the BPP may be optimized upon receiving a plan optimization request from a user. In addition, or alternatively, the BPP may be optimized automatically, without any user request, upon determining that a global recall risk value associated with manufacturing the product batch utilizing the BPP is greater than a desired threshold risk value. In an example, the desired threshold risk value may be included in the plan optimization request. In another example, the desired threshold risk value may be received from the user, post receiving the plan optimization request. In yet another example, the desired threshold risk value may be pre-stored in a memory, say the memory 212, of the system 100 and may be obtained from the memory for comparison with the global recall risk value.

At block 1006, it is ascertained whether the global recall risk value is greater than the desired threshold risk value. For ascertaining whether the global recall risk value is greater than the desired threshold risk value, the desired threshold risk value may be identified or obtained and the global recall risk value may be compared with the desired threshold risk value. Upon determining that the global recall risk value is not greater than the desired threshold risk value, (‘No’ path from block 1006), the BPP may not be optimized and may be kept unchanged, at block 1008. In an example, the user may be notified that the BPP is suitable for producing the product batch and is not required to be optimized.

Upon determining the global recall risk value to be greater than the desired threshold risk value, (‘Yes’ path from block 1006), at least one candidate performance parameter, from amongst the one or more performance parameters, may be identified for improvisation, at block 1010. The at least one candidate performance parameter may be identified for at least one of the plurality of production stages.

At block 1012, at least one candidate control variable governing the at least one candidate performance parameter may be identified. The at least one candidate control variable may be modified to improvise the at least one candidate performance parameter for optimizing the BPP. In one example, the plan optimization request may include the at least one candidate control variable governing the at least one candidate performance parameter of the one or more performance parameters, to be modified within the BPP. Thus, the plan optimization request may be processed to identify the at least one candidate performance parameter for improvisation. Further, the plan optimization request may be processed to identify the at least one candidate control variable which is to be optimized within the BPP.

In another example, if the plan optimization request does not include the at least one candidate control variable governing the at least one candidate performance parameter or recall risk optimization is being implemented without any plan optimization request, the at least one candidate performance parameter and the at least one candidate control variable may be identified through a systematic approach. For example, contribution of each performance parameter and each control variable to the global recall risk value may be analyzed and performance parameters with higher contributions as candidates for improvisation may be prioritized. In another example, sensitivity analysis may be performed to determine how changes in each performance parameter and each control variable affect the global recall risk value, and those performance parameters or control variables may be identified as candidates which show a significant impact on recall risk reduction when improvised. In yet another example, an iterative approach may be used, starting with the most promising candidates and progressively refining selection of the candidates based on the results of initial optimization attempts. In yet another example, the estimated cost and effort required to improve each performance parameter and each control variable may be assessed against the potential recall risk reduction and performance parameters that offer the best recall risk reduction per unit of investment may be identified as the candidates.

At block 1014, the at least one candidate control variable within the BPP may be modified to generate an optimized batch production plan (OBPP) for the product batch. The OBPP may have an optimized global recall risk value equal to or lower than the desired threshold risk value. In an example, the OBPP may be generated in response to receiving the plan optimization request. In another example, the OBPP may be generated without receiving any plan optimization request.

At block 1016, a risk optimization report may be generated for transmission to a user device, say the user device 204. The risk optimization report may include the OBPP. The OBPP incorporates changes that are specifically designed to reduce the global recall risk value of the product batch, enhancing product safety and quality. Thus, the present subject matter provides a comprehensive and proactive approach to recall risk management in complex batch production processes by enabling informed decision-making and targeted optimization. Further, the present subject matter enables dynamic, data-driven optimization of batch productions plans by identifying and modifying control variables across multiple production stages, thereby minimizing recall risks of product batches.

FIG. 10B illustrates the method 1014 for modifying the at least one candidate control variable within the BPP to generate the OBPP at block 1014 of FIG. 10A, according to an example.

At block 1018, an alternate control variable may be determined corresponding to each of the at least one candidate control variable for optimizing the BPP. For example, an alternate control variable “supplier B” may be determined corresponding to a candidate control variable “supplier A” within the BPP. Further, an alternate control variable “transportation mode B” may be determined corresponding to a candidate control variable “transportation mode A” within the BPP. That is, it may be determined that if “supplier A” is replaced with “supplier B” and “transportation mode A” is replaced with “transportation mode B”, then the global recall risk value may be reduced below the desired threshold risk value.

The alternate control variable corresponding to each of the at least one candidate control variable may be determined through a systematic approach. For example, each candidate control variable may be analyzed to understand current settings of the candidate control variable, allowable modification possibilities for the candidate control variable, and impact of modifying the candidate control variable on the BPP. Multiple objectives such as recall risk reduction, product quality improvement, and batch production efficiency may be balanced to determine an optimal alternate control variable corresponding to the control variable. In case any alternate control variable corresponding to any of the at least one candidate control variable is not found, an interactive query dialog may be generated seeking inputs from the user to modify that particular control variable.

At block 1020, each of the at least one candidate control variable may be replaced within the BPP with the corresponding alternate control variable to generate the OBPP for the product batch. The OBPP incorporates changes that are specifically designed to reduce the global recall risk value of the product batch, enhancing product safety and quality.

FIG. 10C illustrates the method 1014 for modifying the at least one candidate control variable within the BPP to generate the OBPP at block 1014 of FIG. 10A, according to another example.

At block 1022, a list of pre-stored control variables associated with the at least one candidate performance parameter may be obtained. For example, a list of raw material suppliers or a list of transportation providers may be obtained. In an example, the list of pre-stored control variables may be obtained from a user associated with the organization. In another example, the list of pre-stored control variables may be pre-stored in a database, say the database 202, and may be obtained from the database. In another example, the list of pre-stored control variables may be pre-stored in a memory, say the memory 212, of the system 100 and may be obtained from the memory.

At block 1024, it may be ascertained whether any pre-stored control variable, from the list of pre-stored control variables, is plausible to be an alternate control variable corresponding to each of the at least one candidate control variable for optimizing the BPP. For example, an alternate control variable “supplier B” in the list of pre-stored control variables may be determined corresponding to a candidate control variable “supplier A” within the BPP. Further, an alternate control variable “transportation mode B” in the list of pre-stored control variables may be determined corresponding to a candidate control variable “transportation mode A” within the BPP. That is, it may be determined that if “supplier A” is replaced with “supplier B” and “transportation mode A” is replaced with “transportation mode B”, then the global recall risk values may be reduced below the desired threshold risk value.

In case, for a candidate control variable of the at least one candidate control variable, it is ascertained that no pre-stored control variable is plausible to be an alternate control variable corresponding to the candidate control variable, (‘No’ path from block 1024), an interactive query dialog may be generated seeking a user input for optimizing the BPP, at block 1026. The BPP may then be optimized based on the user input. In addition, or alternatively, a notification may be generated notifying the user that the list of pre-stored control variables does not include a suitable alternate for the candidate control variable. For example, the notification may state that the list of raw material suppliers does not include a suitable alternate to modify the raw material supplier and suggest the user to find another raw material supplier which is not already present in the list of raw material suppliers.

In case, for a candidate control variable of the at least one candidate control variable, it is ascertained at least one pre-stored control variable is plausible to be an alternate control variable corresponding to the candidate control variable, (‘Yes’ path from block 1024), it may be ascertained whether the candidate control variable has a single alternate control variable in the list of pre-stored control variables, at block 1028.

For each candidate control variable ascertained to have a single alternate control variable in the list of pre-stored control variables, (‘Yes’ path from block 1028), the candidate control variable within the BPP may be replaced with the corresponding single alternate control variable, for generating the OBPP, at block 1030. The OBPP may have an optimized global recall risk value equal to or lower than the desired threshold risk value.

For each candidate control variable ascertained to have a plurality of alternate control variables in the list of pre-stored control variables, (‘No’ path from block 1028), an interactive query dialog may be generated seeking a user input, at block 1032. The interactive query dialog may seek the user input for selecting a particular alternate control variable from the plurality of alternate control variables. The interactive query dialog may be transmitted to a user device, say the user device 204. The interactive query dialog may be a displayed on a user interface of the user device. The interactive query dialog may enable the user to select a particular alternate control variable from the plurality of alternate control variables.

At block 1034, a user input may be received. The user input may specify the particular alternate control variable, for instance, through the user device 204. At block 1036, the candidate control variable within the BPP may be replaced with the particular alternate control variable to generate the OBPP for the product batch. The OBPP incorporates changes that are specifically designed to reduce the global recall risk value of the product batch, enhancing product safety and quality. Thus, the present subject matter enables dynamic, data-driven optimization of batch productions plans by identifying and modifying control variables across multiple production stages, thereby minimizing recall risks of product batches.

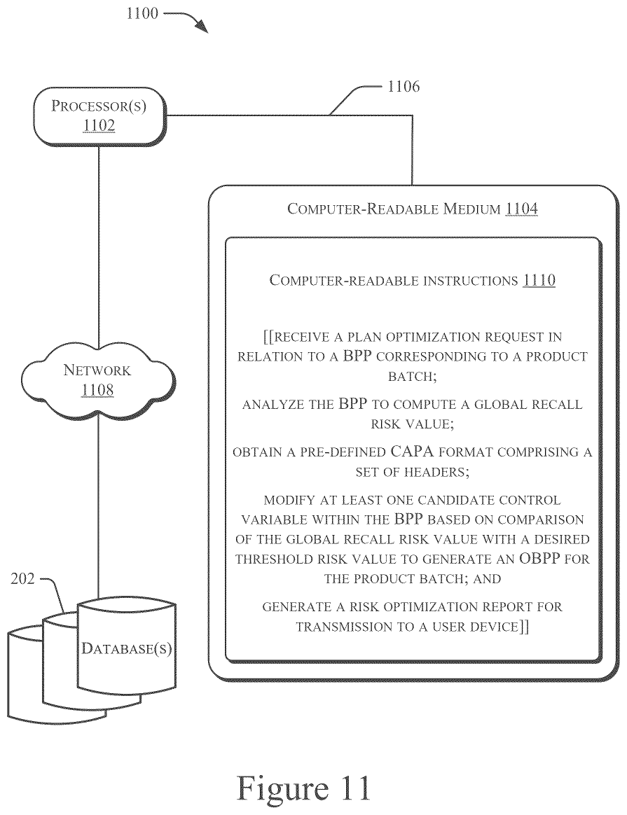

FIG. 11 illustrates a computing environment 1100 implementing a non-transitory computer-readable medium for assessing and optimizing recall risk associated with a product batch, according to an example. In an example, the computing environment 1100 includes processor(s) 1102 communicatively coupled to a non-transitory computer-readable medium 1104 through a communication link 1106. In one example, the communication link 1106 may be similar to the communication network 206, as described in conjunction with the preceding figures. In an example implementation, the computing environment 1100 may be for example, the computing environment 200. In an example, the processor(s) 1102 may have one or more processing resources for fetching and executing computer-readable instructions from the non-transitory computer-readable medium 1104. The processor(s) 1102 and the non-transitory computer-readable medium 1104 may be implemented, for example, in the system 100 (as has been described in conjunction with the preceding figures).

The non-transitory computer-readable medium 1104 may be, for example, an internal memory device or an external memory device. In an example implementation, the communication link 1106 may be a network communication link. The processor(s) 1102 and the non-transitory computer-readable medium 1104 may also be communicatively coupled to the database(s) 202 over a network 1108. The network 1108 may be similar to the communication network 206 described in conjunction with FIG. 2.

In an example implementation, the non-transitory computer-readable medium 1104 may include a set of computer-readable instructions 1110 which may be accessed by the processor(s) 1102 through the communication link 1106. Referring to FIG. 11, in an example, the non-transitory computer-readable medium 1104 may include instructions 1110 that may cause the processor(s) 1102 to receive a plan optimization request in relation to a batch production plan (BPP) corresponding to a product batch. The BPP may describe a plurality of production stages involved in production of the product batch. Further, for each production stage of the plurality of production stages, the BPP may indicate one or more control variables governing one or more performance parameters of the production stage.

For instance, for the raw material sourcing stage, the one or more control variables may include, but are not limited to, raw material specification and raw material supplier specification. For the product manufacturing stage, the one or more control variables may include, but are not limited to, product specification, manufacturing equipment specification, product batch size, environmental conditions, raw material ratios, and product manufacturing process specification. For the product packaging stage, the one or more control variables may include, but are not limited to, packaging material specification, sealing temperature and pressure values, packaging equipment specification, product label information, and product label placement details. For the product storage stage, the one or more control variables may include, but are not limited to, a warehouse address, storage temperature range, light exposure limits, and humidity control settings. For the product distribution stage, the one or more control variables may include, but are not limited to, transportation mode, temperature range during transit, product handling procedure specification, and transportation route.

The one or more performance parameters may be production parameters that are crucial for reducing the recall risk associated with the product batch. The one or more performance parameters of the production stage may be influenced by managing and optimizing the one or more control variables of the production stage. For the raw material sourcing stage, examples of the one or more performance parameters may include, but are not limited to, raw material quality, raw material delay, and supplier issues. For the product manufacturing stage, examples of the one or more performance parameters may include, but are not limited to, product quality, production issues, and contamination issues. For the product packaging stage, example of the one or more performance parameters may include, but is not limited to, packaging defects. For the product storage stage, example of the one or more performance parameters may include, but is not limited to, storage temperature deviations. For the product distribution stage, examples of the one or more performance parameters may include, but are not limited to, production destination issues, transportation delays, shipping steps frequency issues, transportation temperature issues, and location handling issues.

In an example, the plan optimization request may include a desired threshold risk value for recall risk corresponding to the product batch. Further, the plan optimization request may include at least one candidate control variable governing at least one candidate performance parameter of the one or more performance parameters. The at least one candidate control variable is to be modified to improvise the at least one candidate performance parameter for optimizing the BPP.

In an example, the instructions 1110 may cause the processor(s) 1102 to analyze the BPP to compute a global recall risk value associated with manufacturing the product batch utilizing the BPP.

For analyzing the BPP, the instructions 1110 may cause the processor(s) 1102 to obtain the BPP. In an example, the BPP may be obtained from a user associated with the organization. In another example, the BPP may be pre-stored in a memory, say the memory 212, of the system 100 and may be obtained from the memory. Further, for each production stage, the instructions 1110 may cause the processor(s) 1102 to analyze the one or more control variables governing the production stage to determine a parameter-specific recall risk value corresponding to each of the one or more performance parameters of the production stage. In an example, the one or more control variables may be analyzed using a parameter-specific risk determination model. For instance, for the raw material sourcing stage, a first parameter-specific recall risk value may be determined corresponding to the raw material quality, a second parameter-specific recall risk value may be determined corresponding to the raw material delay, and a third parameter-specific recall risk value may be determined corresponding to the supplier issues. Similarly, parameter-specific recall risk values may be determined for the one or more performance parameters of each production stage. The parameter-specific recall risk value may be a quantitative measure that represents the likelihood of recall of the product batch due to issues or deviations associated with the corresponding performance parameter within the corresponding production stage.

The performance parameter may be one of a static performance parameter and a dynamic performance parameter. The static performance parameter may be a parameter being governed by control variables for which the sensor data, such as the actual sensor data or the forecasted sensor data, may either not be available or may not be significant for determining the parameter-specific recall risk value. For example, for a static performance parameter “raw material quality”, actual or real-time evaluation of the raw material may not be done, and the parameter-specific recall risk value may be determined using historical quality ratings associated with the raw material. The dynamic performance parameter may be a parameter being governed by control variables for which the sensor data may be significant for determining the parameter-specific recall risk value.

Thus, for determining a parameter-specific recall risk value corresponding to each static performance parameter of the one or more performance parameters, the instructions 1110 may cause the processor(s) 1102 to obtain historical performance data associated with one or more specific control variables governing the performance parameter. The historical performance data may be obtained using a parameter-specific risk determination model, say the parameter-specific risk determination model 112. In an example, the historical performance data may be obtained from a user associated with the organization. In another example, the historical performance data may be pre-stored in a database, say the database 202, and may be obtained from the database. In another example, the historical performance data may be pre-stored in the memory of the system 100 and may be obtained from the memory. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the performance parameter for which the parameter-specific recall risk value is to be determined.

Subsequently, the instructions 1110 may cause the processor(s) 1102 to analyze the historical performance data using the parameter-specific risk determination model to determine the parameter-specific recall risk value corresponding to the performance parameter. For example, quality ratings of raw material historically supplied by a particular supplier selected within the BPP may be analyzed using a first parameter-specific risk determination model, to determine the parameter-specific recall risk value corresponding to the static performance parameter “raw material quality”. The first parameter-specific risk determination model may be specifically trained to determine the parameter-specific recall risk value based on analysis of the quality ratings.

Further, for determining a parameter-specific recall risk value corresponding to each dynamic performance parameter, the instructions 1110 may cause the processor(s) 1102 to obtain sensor data associated with one or more sensor devices utilized at the production stage. For example, storage temperature associated with a warehouse utilized at the product storage stage may be obtained. The sensor data may be obtained using the parameter-specific risk determination model. In an example, the sensor data may be obtained from a user associated with the organization. In another example, the sensor data may be pre-stored in the database and may be obtained from the database. In another example, the sensor data may be pre-stored in the memory of the system 100 and may be obtained from the memory.

The sensor data may include at least one of actual sensor data and forecasted sensor data. The actual sensor data may be obtained from the one or more sensor devices that sense the actual sensor data. Thus, the instructions 1110 may cause the processor(s) 1102 to receive the actual sensor data from the one or more sensor devices in real-time. For example, the actual sensor data may be received from one or more temperature sensors installed in the warehouse. In addition, or alternatively, the instructions 1110 may cause the processor(s) 1102 to analyze one or more specific control variables governing the dynamic performance parameter to generate the forecasted sensor data. For example, the forecasted sensor data may be generated based on weather forecasting for the date at which the product batch is scheduled to be stored, temperature insulation properties of the warehouse, and historical temperature setting records of the warehouse.

The instructions 1110 may further cause the processor(s) 1102 to obtain historical performance data associated with the sensor data and the one or more specific control variables governing the performance parameter. The historical performance data may be obtained using the parameter-specific risk determination model. In an example, the historical performance data may be obtained from a user associated with the organization. In another example, the historical performance data may be pre-stored in the database and may be obtained from the database. In another example, the historical performance data may be pre-stored in the memory of the system 100 and may be obtained from the memory. Examples of the historical performance data may include, but are not limited to, equipment performance logs, raw material supplier performance metrics, past recall incidents, past recall causes, manufacturing process efficiency measurements, packaging process efficiency measurements, warehouse efficiency measurements, and transportation performance metrics. The obtained historical performance data is specific to the performance parameter for which the parameter-specific recall risk value is to be determined.

Once the sensor data and the historical performance data are obtained, the instructions 1110 may cause the processor(s) 1102 to analyze the sensor data and the historical performance data to determine the parameter-specific recall risk value corresponding to the performance parameter. The sensor data and the historical performance data may be analyzed using the parameter-specific risk determination model and a data assimilation framework, such as a Kalman filter. For example, the sensor data, past temperature insulation properties of the warehouse, and historical temperature setting records of the warehouse may be analyzed using a second parameter-specific risk determination model, to determine the parameter-specific recall risk value corresponding to a dynamic performance parameter “storage temperature deviations”. The second parameter-specific risk determination model may be specifically trained to determine the parameter-specific recall risk value based on analysis of the sensor data, the past temperature insulation properties, and the historical temperature setting records.

Once the parameter-specific recall risk values are determined for the one or more performance parameters of each production stage, for each production stage, the instructions 1110 may cause the processor(s) 1102 to aggregate parameter-specific recall risk values determined for the one or more performance parameters to generate a stage-specific recall risk value for the production stage. In an example, the parameter-specific recall risk values may be aggregated utilizing different statistical methods, such a Bayesian mechanism. The stage-specific recall risk value may be a comprehensive measure that represents the overall likelihood of recall of the product batch due to issues or deviations associated with an entire production stage of the BPP. Further, for each production stage, the instructions 1110 may cause the processor(s) 1102 to aggregate stage-specific recall risk values generated for the plurality of production stages to generate a global recall risk value associated with manufacturing the product batch utilizing the BPP. In an example, the stage-specific recall risk values may be aggregated utilizing different statistical methods, such a Bayesian mechanism. The global recall risk value may be a comprehensive measure that represents the overall likelihood of recall of the product batch if the product batch is produced using the BPP. In an example, the instructions 1110 may cause the processor(s) 1102 to generate a risk assessment report for the product batch for transmission to a user device, say the user device 204. The risk assessment report may be a structured document containing key information about recall risk assessment for the product batch. The risk assessment report may include the global recall risk value.

Once the global recall risk value is computed, the instructions 1110 may cause the processor(s) 1102 to modify the at least one candidate control variable within the BPP based on comparison of the global recall risk value with the desired threshold risk value to generate an optimized batch production plan (OBPP) for the product batch. The OBPP may have an optimized global recall risk value equal to or lower than the desired threshold risk value. In an example, the BPP may be optimized upon receiving the plan optimization request from the user. In addition, or alternatively, the BPP may be optimized automatically, without any user request, upon determining that the global recall risk value is greater than the desired threshold risk value. In an example, if the desired threshold risk value is not included in the plan optimization request, the desired threshold risk value may be received from the user, post receiving the plan optimization request. In yet another example, the desired threshold risk value may be pre-stored in the memory of the system 100 and may be obtained from the memory for comparison with the global recall risk value.

In case the at least one candidate control variable is not included in the plan optimization request or the BPP is being optimized without the plan optimization request upon determining that the global recall risk value is greater than the desired threshold risk value, the instructions 1110 may cause the processor(s) 1102 to identify at least one candidate performance parameter, from amongst the one or more performance parameters, for improvisation. The at least one candidate performance parameter may be identified for at least one of the plurality of production stages. Further, the instructions 1110 may cause the processor(s) 1102 to identify the at least one candidate control variable governing the at least one candidate performance parameter, where the at least one candidate control variable may be modified to improvise the at least one candidate performance parameter for optimizing the BPP. The at least one candidate control variable may be identified through a systematic approach. For example, contribution of each performance parameter and each control variable to the global recall risk value may be analyzed and performance parameters with higher contributions as candidates for improvisation may be prioritized. In another example, sensitivity analysis may be performed to determine how changes in each performance parameter and each control variable affect the global recall risk value, and those performance parameters or control variables may be identified as candidates which show a significant impact on recall risk reduction when improvised. In yet another example, an iterative approach may be used, starting with the most promising candidates and progressively refining selection of the candidates based on the results of initial optimization attempts. In yet another example, the estimated cost and effort required to improve each performance parameter and each control variable may be assessed against the potential recall risk reduction and performance parameters that offer the best recall risk reduction per unit of investment may be identified as the candidates.

In an example, for modifying the at least one candidate control variable within the BPP to generate the OBPP, the instructions 1110 may cause the processor(s) 1102 to determine an alternate control variable corresponding to each of the at least one candidate control variable for optimizing the BPP. For example, an alternate control variable “supplier B” may be determined corresponding to a candidate control variable “supplier A” within the BPP. Further, an alternate control variable “transportation mode B” may be determined corresponding to a candidate control variable “transportation mode A” within the BPP. That is, it may be determined that if “supplier A” is replaced with “supplier B” and “transportation mode A” is replaced with “transportation mode B”, then the global recall risk value may be reduced below the desired threshold risk value.

The alternate control variable corresponding to each of the at least one candidate control variable may be determined through a systematic approach. For example, each candidate control variable may be analyzed to understand current settings of the candidate control variable, allowable modification possibilities for the candidate control variable, and impact of modifying the candidate control variable on the BPP. Multiple objectives such as recall risk reduction, product quality improvement, and batch production efficiency may be balanced to determine an optimal alternate control variable corresponding to the control variable. In case any alternate control variable corresponding to any of the at least one candidate control variable is not found, an interactive query dialog may be generated seeking inputs from the user to modify that particular control variable.

The instructions 1110 may further cause the processor(s) 1102 to replace each of the at least one candidate control variable within the BPP with the corresponding alternate control variable to generate the OBPP for the product batch. The OBPP incorporates changes that are specifically designed to reduce the global recall risk value of the product batch, enhancing product safety and quality.

In another example, for modifying the at least one candidate control variable within the BPP to generate the OBPP, he instructions 1110 may cause the processor(s) 1102 to obtain a list of pre-stored control variables associated with the at least one candidate performance parameter. For example, a list of raw material suppliers or a list of transportation providers may be obtained. In an example, the list of pre-stored control variables may be obtained from a user associated with the organization. In another example, the list of pre-stored control variables may be pre-stored in the database and may be obtained from the database. In another example, the list of pre-stored control variables may be pre-stored in the memory of the system 100 and may be obtained from the memory.

Further, the instructions 1110 may cause the processor(s) 1102 to ascertain whether any pre-stored control variable, from the list of pre-stored control variables, is plausible to be an alternate control variable corresponding to each of the at least one candidate control variable for optimizing the BPP. For example, an alternate control variable “supplier B” in the list of pre-stored control variables may be determined corresponding to a candidate control variable “supplier A” within the BPP. Further, an alternate control variable “transportation mode B” in the list of pre-stored control variables may be determined corresponding to a candidate control variable “transportation mode A” within the BPP. That is, it may determine that if “supplier A” is replaced with “supplier B” and “transportation mode A” is replaced with “transportation mode B”, then the global recall risk values may be reduced below the desired threshold risk value. In case any alternate control variable is not found corresponding to any of the at least one candidate control variable, an interactive query dialog may be generated seeking inputs from the user to modify that particular control variable. In addition, or alternatively, a notification may be generated to notify the user that the list of pre-stored control variables does not include a suitable alternate for that particular control variable. For example, the notification may state that the list of raw material suppliers does not include a suitable alternate to modify the raw material supplier and suggest the user to find another raw material supplier which is not already present in the list of raw material suppliers.

Subsequently, for each candidate control variable ascertained to have a single alternate control variable in the list of pre-stored control variables, the instructions 1110 may cause the processor(s) 1102 to replace the candidate control variable within the BPP with the corresponding single alternate control variable, for generating the OBPP.

Further, for each candidate control variable ascertained to have a plurality of alternate control variables in the list of pre-stored control variables, the instructions 1110 may cause the processor(s) 1102 to generate an interactive query dialog seeking a user input for selecting a particular alternate control variable from the plurality of alternate control variables. The interactive query dialog may be transmitted to the user device. The instructions 1110 may further cause the processor(s) 1102 to receive a user input specifying the particular alternate control variable. The instructions 1110 may then cause the processor(s) 1102 to replace the candidate control variable within the BPP with the particular alternate control variable to generate the OBPP for the product batch.

Once the at least one candidate control variable is modified, the instructions 1110 may cause the processor(s) 1102 to generate a risk optimization report for transmission to the user device. The risk optimization report may include the OBPP. The OBPP incorporates changes that are specifically designed to reduce the global recall risk value of the product batch, enhancing product safety and quality. Thus, the present subject matter provides a comprehensive and proactive approach to recall risk management in complex batch production processes by integrating risk assessments from multiple production stages into a unified and accurate global risk profile, enabling informed decision-making and targeted optimization. Further, the present subject matter enables dynamic, data-driven optimization of batch productions plans by identifying and modifying control variables across multiple production stages, thereby minimizing recall risks of product batches.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a batch risk assessment engine to:
obtain a batch production plan (BPP) corresponding to a product batch, the BPP describing a plurality of production stages involved in production of the product batch, wherein, for each production stage of the plurality of production stages, the BPP indicates one or more control variables governing one or more performance parameters of the production stage;
for each production stage:
analyze, using a parameter-specific risk determination model, the one or more control variables governing the production stage, to determine a parameter-specific recall risk value corresponding to each of the one or more performance parameters of the production stage; and
aggregate parameter-specific recall risk values determined for the one or more performance parameters to generate a stage-specific recall risk value for the production stage; and
aggregate stage-specific recall risk values generated for the plurality of production stages to generate a global recall risk value associated with manufacturing the product batch utilizing the BPP; and
a report generation engine to:
generate a risk assessment report for the product batch for transmission to a user device, wherein the risk assessment report includes the global recall risk value.

2. The system of claim 1, wherein the batch risk assessment engine is to:
for each performance parameter of the one or more performance parameters, if the performance parameter is a static performance parameter:
obtain, using the parameter-specific risk determination model, historical performance data associated with one or more specific control variables governing the performance parameter; and
analyze, using the parameter-specific risk determination model, the historical performance data to determine the parameter-specific recall risk value corresponding to the performance parameter.

3. The system of claim 1, wherein the batch risk assessment engine is to:
for each performance parameter of the one or more performance parameters if the performance parameter is a dynamic performance parameter:
obtain, using the parameter-specific risk determination model, sensor data associated with one or more sensor devices utilized at the production stage;
obtain, using the parameter-specific risk determination model, historical performance data associated with the sensor data and one or more specific control variables governing the performance parameter; and
analyze, using the parameter-specific risk determination model, the sensor data and the historical performance data to determine the parameter-specific recall risk value corresponding to the performance parameter.

4. The system of claim 3, wherein, the batch risk assessment engine is to:
for the sensor data being actual sensor data sensed by the one or more sensor devices, receive the actual sensor data from the one or more sensor devices in real-time.

5. The system of claim 3, wherein, the batch risk assessment engine is to:
for the sensor data being forecasted sensor data, analyze the one or more specific control variables governing the performance parameter to generate the forecasted sensor data.

6. The system of claim 1, wherein the system comprises:
a plan optimization engine to:
upon determining the global recall risk value to be greater than a desired threshold risk value, identify, for at least one of the plurality of production stages, at least one candidate performance parameter, from amongst the one or more performance parameters, for improvisation;
identify at least one candidate control variable governing the at least one candidate performance parameter, wherein the at least one candidate control variable is to be modified to improvise the at least one candidate performance parameter for optimizing the BPP;
modify the at least one candidate control variable within the BPP to generate an optimized batch production plan (OBPP) for the product batch, the OBPP having an optimized global recall risk value equal to or lower than the desired threshold risk value; and
generating a risk optimization report for transmission to a user device, wherein the risk optimization report includes the OBPP.

7. The system of claim 6, wherein the plan optimization engine is to:
receive a plan optimization request in relation to the BPP, wherein the plan optimization request includes:
the desired threshold risk value, and
the at least one candidate control variable, governing the at least one candidate performance parameter of the one or more performance parameters, to be modified within the BPP, wherein the OBPP is generated in response to receiving the plan optimization request; and
analyze the plan optimization request to identify the at least one candidate performance parameter and the at least one candidate control variable.

8. A method comprising:
obtaining a batch production plan (BPP) corresponding to a product batch, the BPP describing a plurality of production stages involved in production of the product batch, wherein, for each production stage of the plurality of production stages, the BPP indicates one or more control variables governing one or more performance parameters of the production stage;
analyzing the BPP to compute a global recall risk value associated with manufacturing the product batch utilizing the BPP, wherein the global recall risk value is recurrently updated during implementation of the BPP;
upon determining the global recall risk value to be greater than a desired threshold risk value, identifying, for at least one of the plurality of production stages, at least one candidate performance parameter, from amongst the one or more performance parameters, for improvisation;
identifying at least one candidate control variable governing the at least one candidate performance parameter, wherein the at least one candidate control variable is to be modified to improvise the at least one candidate performance parameter for optimizing the BPP;
modifying the at least one candidate control variable within the BPP to generate an optimized batch production plan (OBPP) for the product batch, the OBPP having an optimized global recall risk value equal to or lower than the desired threshold risk value; and
generating a risk optimization report for transmission to a user device, wherein the risk optimization report includes the OBPP.

9. The method of claim 8, wherein analyzing the BPP to compute the global recall risk value associated with manufacturing the product batch utilizing the BPP comprises:
for each production stage:
analyzing, using a parameter-specific risk determination model, the one or more control variables governing the production stage, to determine a parameter-specific recall risk value corresponding to each of the one or more performance parameters of the production stage; and
aggregating parameter-specific recall risk values determined for the one or more performance parameters to generate a stage-specific recall risk value for the production stage; and
aggregating stage-specific recall risk values generated for the plurality of production stages to generate the global recall risk value.

10. The method of claim 8, wherein the method comprises:
receiving a plan optimization request in relation to the BPP, wherein the plan optimization request includes the desired threshold risk value and the at least one candidate control variable governing the at least one candidate performance parameter of the one or more performance parameters, to be modified within the BPP, wherein the OBPP is generated in response receiving the plan optimization request.

11. The method of claim 10, wherein identifying the at least one candidate performance parameter for at least one of the plurality of production stages comprises:
processing the plan optimization request to determine the at least one candidate performance parameter for improvisation.

12. The method of claim 10, wherein identifying the at least one candidate control variable governing the at least one candidate performance parameter comprises:
processing the plan optimization request to identify the at least one candidate control variable which is to be optimized within the BPP.

13. The method of claim 10, wherein modifying the at least one candidate control variable within the BPP to generate the OBPP comprises:
determining an alternate control variable corresponding to each of the at least one candidate control variable for optimizing the BPP; and
replacing each of the at least one candidate control variable within the BPP with the corresponding alternate control variable to generate the OBPP for the product batch.

14. The method of claim 10, wherein modifying the at least one candidate control variable within the BPP to generate the OBPP comprises:
obtaining a list of pre-stored control variables associated with the at least one candidate performance parameter;
ascertaining whether any pre-stored control variable, from the list of pre-stored control variables, is plausible to be an alternate control variable corresponding to each of the at least one candidate control variable for optimizing the BPP; and
for generating the OBPP:
for each candidate control variable ascertained to have a single alternate control variable in the list of pre-stored control variables, replacing the candidate control variable within the BPP with the corresponding single alternate control variable; and
for each candidate control variable ascertained to have a plurality of alternate control variables in the list of pre-stored control variables:
generating an interactive query dialog seeking a user input for selecting a particular alternate control variable from the plurality of alternate control variables;
receiving a user input specifying the particular alternate control variable; and
replacing the candidate control variable within the BPP with the particular alternate control variable.

15. A non-transitory computer-readable medium comprising instructions for assessing and optimizing recall risk associated with a product batch, the instructions being executable by a processing resource to:
receive a plan optimization request in relation to a batch production plan (BPP) corresponding to a product batch, the BPP describing a plurality of production stages involved in production of the product batch, wherein, for each production stage of the plurality of production stages, the BPP indicates one or more control variables governing one or more performance parameters of the production stage, wherein the plan optimization request includes:
a desired threshold risk value for recall risk corresponding to the product batch, and
at least one candidate control variable, governing at least one candidate performance parameter of the one or more performance parameters, to be modified to improvise the at least one candidate performance parameter for optimizing the BPP;
analyze the BPP to compute a global recall risk value associated with manufacturing the product batch utilizing the BPP;
modify the at least one candidate control variable within the BPP based on comparison of the global recall risk value with the desired threshold risk value to generate an optimized batch production plan (OBPP) for the product batch, the OBPP having an optimized global recall risk value equal to or lower than the desired threshold risk value; and
generate a risk optimization report for transmission to a user device, wherein the risk optimization report includes the OBPP.

16. The non-transitory computer-readable medium of claim 15, wherein to analyze the BPP to compute the global recall risk value associated with manufacturing the product batch utilizing the BPP, the instructions are executable by the processing resource to:
for each production stage:
analyze, using a parameter-specific risk determination model, the one or more control variables governing the production stage, to determine a parameter-specific recall risk value corresponding to each of the one or more performance parameters of the production stage; and
aggregate parameter-specific recall risk values determined for the one or more performance parameters to generate a stage-specific recall risk value for the production stage; and
aggregate stage-specific recall risk values generated for the plurality of production stages to generate the global recall risk value.

17. The non-transitory computer-readable medium of claim 15, wherein to modify the at least one candidate control variable within the BPP to generate the OBPP, the instructions are executable by the processing resource to:
obtain a list of pre-stored control variables associated with the at least one candidate performance parameter;
ascertain whether any pre-stored control variable, from the list of pre-stored control variables, is plausible to be an alternate control variable corresponding to each of the at least one candidate control variable for optimizing the BPP; and
for generating the OBPP:
for each candidate control variable ascertained to have a single alternate control variable in the list of pre-stored control variables, replace the candidate control variable within the BPP with the single alternate control variable; and
for each candidate control variable ascertained to have a plurality of alternate control variables in the list of pre-stored control variables:
generate an interactive query dialog seeking a user input for selecting a particular alternate control variable from the plurality of alternate control variables;
receive a user input specifying the particular alternate control variable; and
replace the candidate control variable within the BPP with the particular alternate control variable.

18. The non-transitory computer-readable medium of claim 16, wherein the instructions are executable by the processing resource to:
for each performance parameter of the one or more performance parameters, if the performance parameter is a static performance parameter:
obtain, using the parameter-specific risk determination model, historical performance data associated with one or more specific control variables governing the performance parameter; and
analyze, using the parameter-specific risk determination model, the historical performance data to determine the parameter-specific recall risk value corresponding to the performance parameter.

19. The non-transitory computer-readable medium of claim 16, wherein the instructions are executable by the processing resource to:
for each performance parameter of the one or more performance parameters, if the performance parameter is a dynamic performance parameter:
obtain, using the parameter-specific risk determination model, sensor data associated with one or more sensor devices utilized at the production stage;
obtain, using the parameter-specific risk determination model, historical performance data associated with the sensor data and one or more specific control variables governing the performance parameter; and
analyze, using the parameter-specific risk determination model, the sensor data and the historical performance data to determine the parameter-specific recall risk value corresponding to the performance parameter.

20. The non-transitory computer-readable medium of claim 19, wherein the sensor data is one of:
actual sensor data obtained from the one or more sensor devices that sense the actual sensor data; and
forecasted sensor data generated based on analysis of the one or more specific control variables governing the performance parameter.
